(19) United States
(12) Patent Application Publication
(10) Pub. No.: US 2021/0135866 A1
(43) Pub. Date: May 6, 2021

(54) System and Method for Efficiency in Interoperability

(71) Applicant: Rohan HALL, Irvine, CA (US)

(72) Inventor: Rohan HALL, Irvine, CA (US)

(73) Assignee: Vottun, Inc., Irvine, CA (US)

(21) Appl. No.: 16/974,175

(22) Filed: Nov. 2, 2020

Related U.S. Application Data
(60) Provisional application No. 62/930,064, filed on Nov. 4, 2019.

(51) Int. Cl. H04L 9/30; G06Q 50/18

(52) U.S. Cl. CPC H04L 9/30; G06Q 50/18

(57) ABSTRACT

Systems and methods for efficient operation of computing devices related to transmission and retrieval of data from multiple distributed ledgers are provided, in which the system houses incorporates and API to permit the posting and retrieval of data to and from such ledgers. Use of validation of multiple ledgers and a common identifier for related data provides for efficient operation of the hardware and databases to reduce processing time and increase processing speeds. Such systems and methods permit coordinated interaction of multiple posting and retrieval computers while maintaining accuracy and interoperability of the data in each of the multiple ledgers, whether public or private.

### CROSS-REFERENCE TO RELATED APPLICATION

This application claims the benefit of U.S. Provisional Application No. 62/930,064, filed Nov. 4, 2019.

### TECHNICAL FIELD

The disclosure is directed to efficiency in systems that relate to data storage and modification of stored data, particularly in systems in which data is stored in distributed databases that may ordinarily be incompatible.

### BACKGROUND

Blockchain has emerged as a preferred data storage medium with numerous use cases. Blockchain permits storage of data in a distributed manner that may secured or publicly available. Blockchain provides a significant benefit insofar as the distributed ledger of past data recording transactions is immutable and attempts to change the record of past transactions will fail in a distributed system, because adding data to a given blockchain dataset requires confirmation of the record of past transactions, a confirmation that is often performed by multiple distributed computers (or nodes).

Because of the characteristics of blockchain that many see as desirable, the technology has led to multiple varieties of both public and private blockchains. These include blockchains referred to as Ethereum, Hyperledger, and Alastria. Multiple forks of blockchains have been created where the users or developers of a particular blockchain become misaligned or desire to introduce different features or software within the functional structure or definition of the blockchain. It is anticipated that additional blockchain technologies and additional forks of existing or new blockchains will likely be created in the future.

One problem that arises with the multitude of blockchains that are currently in existence is the ability for one user, company, institution, or other entity to read and write information to various blockchains. For example, a department within a large institution such as a university or large company may wish to use one type of blockchain to store a first type of data, such as degrees granted to students or products shipped to customers. However, a different department within the same university or company may wish to use a different type of blockchain to store a different type of data, such as student birthdates or supply chain information. Each blockchain may be well suited to the particular type of function for which it is used, perhaps having different security features, costs of use, distributions, accessibility, etc. However, the time may come where a user needs to cross-reference data, in the stated example, perhaps cross-referencing degrees with birthdates or cross-referencing sales data with supply chain data. This may be difficult where the different types of data are stored upon different publicly distributed blockchains. It may be more difficult where one of the blockchains is a private blockchain maintained only by the relevant institution.

Each blockchain may have its own protocols for writing or reading data. Each blockchain may have its own costs for writing or reading data. Blockchains may store data in different manners, including the use of encryption or distributed file systems such as IPFS. Complicating this, the technical nature of interacting with blockchains is often very difficult for a layperson to navigate, perhaps resulting in underuse of blockchain technology by persons who could benefit from the technology.

Many blockchains employ technology known as “smart contracts.” While the term “smart contract” may be a misnomer, because such technology merely implements logic rather than intelligence, the term is in common use and will be employed herein. In general, smart contracts are computer programs or transaction protocols that are intended to automatically execute, control, or document relevant events according to predetermined logic or agreements. As implemented in software with respect to blockchains, smart contracts allow for a reduction in the need for trusted intermediators and other checks on behavior, because the contracts implement a logic that cannot easily be violated by an untrustworthy actor. The use of smart contracts can further complicate blockchain technology for lay persons.

Adding to the technical complication of blockchain is a layer of determining whether the proper blockchain is being used for a transaction. This determination, or validation, of the proper blockchain may also be beyond the technical knowledge of a layperson. Thus, a layperson attempting to read from or write to a blockchain may unknowingly use an outdated or invalid version of the database.

Based upon the promise of the blockchain technology coupled with the potential pitfalls of use by the laypersons or the general public, systems and methods that increase the efficiency of computers in the use of such technology are needed. Such systems and methods are needed for confirming various blockchains for transactions, receiving key information for such block chains, validating such blockchains, automatically accessing smart contracts for such block chains, posting data to such blockchains via smart contracts, and retrieving data from such block chains. Systems are needed where these things can be accomplished with respect to identifiable batches of data. Systems are needed for interaction with multiple types of blockchains, including at least Ethereum, Alastria, and Hyperledger. Systems are needed for interaction with private or yet-to-emerge blockchain technologies.

The above-described issues are merely intended to provide an overview of some of the problems of conventional systems and methods, and are not intended to be exhaustive. Other problems with conventional systems and corresponding benefits of the various non-limiting embodiments described herein may become further apparent upon review of the following description.

### SUMMARY

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later.

Thus, in non-limiting embodiments, the disclosed subject matter relates to systems, software and services and, more specifically, relates to system, software and services that facilitate creating and using more than one type of blockchain in an interoperable manner, and so on. In one non-limiting aspect, the disclosed subject matter can comprise validating blockchains for interaction. In further non-limiting aspects, the disclosed subject matter can comprise accessing smart contracts associated with validated block chains, based upon the type of smart contract and type of blockchain. In still further non-limiting aspects, the disclosed subject matter can comprise posting data to and/or retrieving data from multiple blockchains in an interoperable manner. Interoperability can be explained in a technical sense as the ability or characteristics of a system with an interface adaptable for implementation of multiple third party systems thereby efficiently rendering the exchange of information between the systems as accessible to a user as if all third party systems were parts of a single system.

To the foregoing and related ends, systems, devices, and methods are disclosed that can facilitate receiving a collection of data to be posted in a plurality of blockchains, receiving public key information for the blockchains, attempting to validate the blockchains, when the blockchains are validated, accessing smart contracts associated with the validated blockchains, posting data and public key information to the blockchains via smart contracts associated with the validated blockchains.

In addition, non-limiting embodiments of the disclosed subject matter can provide exemplary systems and methods that assign batch identifiers to collections of data, post batch identifiers to validated blockchains using smart contracts, retrieve batch identifiers from validated blockchains and associate the identifiers with appropriate batches of data, retrieve public key information when retrieving data items, decrypt data items using the public key and a private key, interact with blockchains including Ethereum, Alastria, and Hyperledger.

In addition, further exemplary implementations are directed to other exemplary systems, methods, devices and/or other articles of manufacture that facilitate creating and using various blockchains, as further detailed herein.

These and other features of the disclosed subject matter are described in more detail below.

### BRIEF DESCRIPTION OF THE DRAWINGS

The systems, devices, components, and methods of the disclosed subject matter are further described with reference to the accompanying FIGs, in which:

FIG. 1 depicts a functional block diagram illustrating an exemplary environment suitable for use with aspects of the disclosed subject matter;

FIG. 2 illustrates an exemplary block diagram showing non-limiting aspects of embodiments of the disclosed subject matter;

FIG. 3 illustrates an exemplary block diagram showing further non-limiting aspects of embodiments of the disclosed subject matter;

FIG. 4 illustrates a block diagram of an exemplary manner in which a system conforming with the present inventions may be developed;

FIG. 5 illustrates an exemplary block diagram of a conceptual framework according to non-limiting aspects of embodiments of the disclosed subject matter;

FIG. 6 illustrates an exemplary block diagram showing exemplary non-limiting aspects of embodiments of the disclosed subject matter;

FIG. 7 illustrates an exemplary block diagram showing exemplary non-limiting aspects of embodiments of the disclosed subject matter;

FIG. 8 illustrates an exemplary block diagram showing exemplary non-limiting aspects of embodiments of the disclosed subject matter;

FIG. 9 illustrates an exemplary block diagram showing exemplary non-limiting aspects of embodiments of the disclosed subject matter;

FIG. 10 illustrates an exemplary block diagram showing exemplary non-limiting aspects of embodiments of the disclosed subject matter;

FIG. 11 shows a block diagram of an illustrative exemplary embodiment 1200 of the inventive system and method with respect to the posting of data having a common identifier.

FIG. 12 shows a block diagram of an illustrative exemplary embodiment 1200 of the inventive system and method with respect to the retrieval and reconstruction of data having a common identifier.

FIG. 13 depicts a functional block diagram illustrating exemplary non-limiting devices or systems suitable for use with aspects of the disclosed subject matter;

FIG. 14 illustrates an overview of an exemplary computing environment suitable for incorporation of embodiments of the disclosed subject matter;

FIG. 15 depicts an exemplary non-limiting device or system suitable for performing various aspects of the disclosed subject matter;

FIG. 16 illustrates an exemplary non-limiting device or system suitable for performing various aspects of the disclosed subject matter

FIG. 17 is a block diagram representing exemplary non-limiting networked environments in which various embodiments described herein can be implemented;

FIG. 18 is a block diagram representing an exemplary non-limiting computing system or operating environment in which one or more aspects of various embodiments described herein can be implemented; and

FIG. 19 illustrates a schematic diagram of an exemplary mobile device (e.g., a mobile handset) that can facilitate various non-limiting aspects of the disclosed subject matter in accordance with the embodiments described herein.

### DETAILED DESCRIPTION OF ILLUSTRATIVE EMBODIMENTS

As described above, conventional processes for interaction with multiple types of blockchains are potentially insecure, technologically challenging for lay persons, and generally incompatible among various types of blockchains, such that conventional efforts for interacting among multiple blockchains fail to provide meaningful solutions that are both efficient for the computing systems and manageable for the persons using the systems, etc., among other deficiencies.

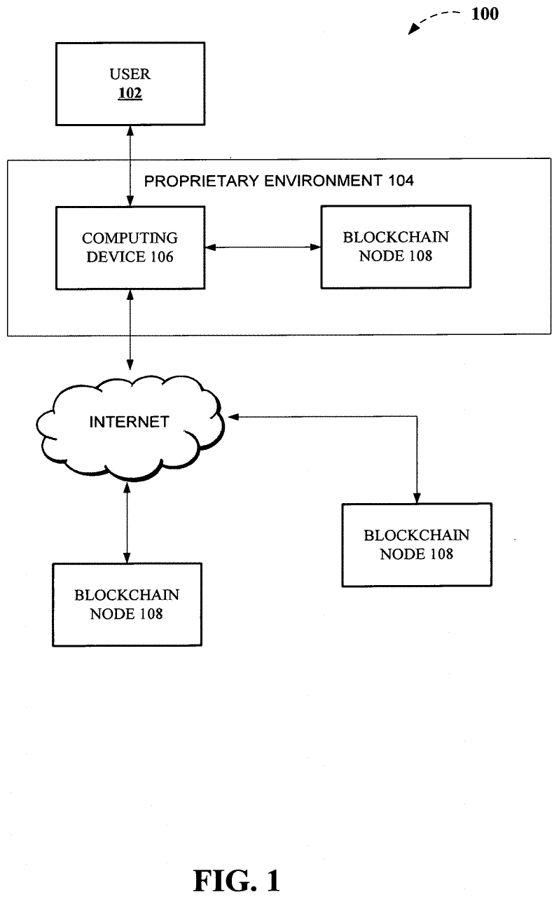

FIG. 1 depicts a functional block diagram illustrating an exemplary environment 100 suitable for use with aspects of the disclosed subject matter. For instance, it depicts an exemplary set of parties or participants communicatively coupled to each other and involved in the provision, collection, use, and distribution of information. For example, a user 102 operating a computing device 106, such as the devices described in more detail below, operate within a proprietary environment 104. Proprietary environment 104 may be a company network, university network, or other non-public network that may be secured by firewall or other security mechanism(s). Proprietary environment 104 may contain at least one computing device 106, and may contain multiple such computing devices. For purposes of simplicity, only one such computing device 106 is illustrated within proprietary environment 104. Proprietary environment 104 may include one or more nodes 108 of a distributed ledger or blockchain. The node(s) 108 may be nodes of a proprietary blockchain or a publicly distributed blockchain.

Proprietary environment 104 may be connected to the internet, such that user 102 using computing device 106 can connect to the internet. In the alternative, computer device 106 may be a standalone device such that user 102 using computing device 106 may connect directly to the internet or another publicly accessible computing network, rather than connecting through proprietary environment 104.

The internet may be connected to one or multiple nodes 108 of distributed ledgers such as blockchains. Such nodes 108 may be nodes of a single distributed ledger or nodes of multiple distributed ledgers such as Ethereum, Alastria, Hyperledger, or other blockchains.

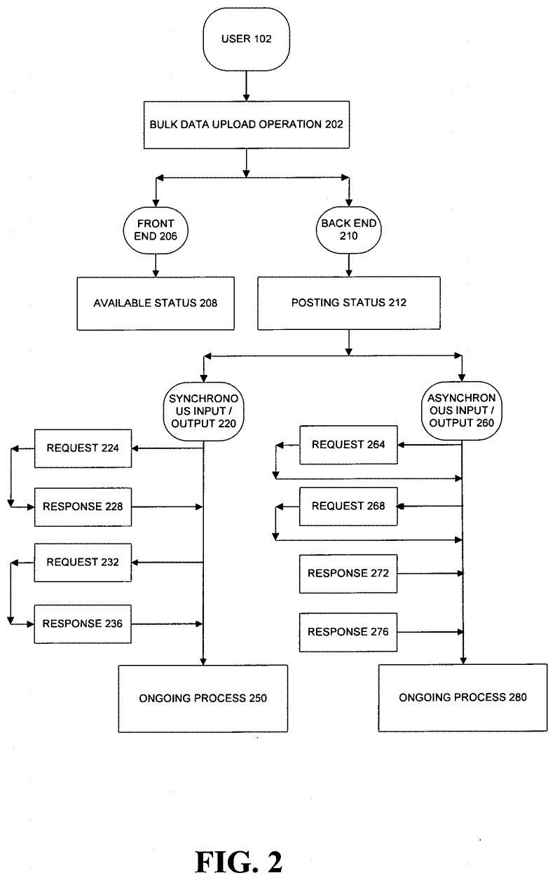

Referring to FIG. 2, a block diagram presenting exemplary embodiments 200 of the claimed invention are set forth. A user 102 may engage a computing system, such as that illustrated in FIG. 1 or discussed below in a bulk data upload operation 202, in which user 102 desires to upload a bulk set of data to a blockchain via a bulk upload operation 202. By way of example only, such data may be related to domains including education, supply chain, identification, financial services, food traceability, among others. Each of such domains and other domains typically has its own set of typical operations that may include variations even within the domain. Thus, rendering such operations more efficient by enhancing the manner in which the hardware and software operate is a desirable result of the inventions disclosed herein.

An exemplary use case in the educational domain may consist of the operation of allowing a user 102 (in the form of a University employee or set of University employees) to post achievements of one or multiple students to one or more blockchains so that the information can be stored and recorded in a manner that is not subject to later tampering or alteration. It may also be desirable to post such achievements in a secure manner that will permit students to provide potential employers or other entities with the ability to gain access for a limited or extended period of time for credential checking or other purposes, potentially while relieving the educational institution of the need to maintain staff for verifications or even to relieve the need to maintain a separate or proprietary data store with such information. For example, a certificate publicly posted to various blockchains can easily be retrieved and authenticated by a student or by any other organization desiring to confirm the authenticity of the certificate. A student may link such certificates to a virtual wallet, social media, email, or in other manners in which the student maintains data relating to the certificates. In the education domain example, the inventive system may be configured to permit numerous operations relating to posting data or retrieving data from such blockchains. By way of example, such data posting operations may include adding a student, adding a course, adding a certificate, creating achievements, adding an existing student email, adding a date with the wrong format or the correct format, etc. As a further example, the data retrieval operations may include retrieving a student list, retrieving a certificate list, retrieving a course list, retrieving an achievement list, etc.

In this example, a user 102 may desire to post a number (N) of achievements to a blockchain. The user 102 uploads the N achievements to the computing device 106 for upload to an internal or publicly distributed blockchain. The user 102 may be prompted to choose among a plurality of blockchains to which the information may be posted. If provided with appropriate options, the user 102 may select one, a subset, or the complete set of the presented blockchains. Or, in the alternative, the user 102 may select to post a first set of information to one blockchain (e.g., Ethereum) and a second set of information to a different blockchain (e.g., Alastria), and a third set of information to yet a different blockchain (e.g., Hyperledger). In many blockchain systems, posting such information results in the reduction of currency, whether fiat, virtual, or other in a user's account, which can be accomplished through the mechanism of the blockchain or by a third party payment system using a virtual wallet and/or smart contracts.

The user 102 may interact with a front end system 206 that has an available status 208. The user 102 may begin the data upload operation 202 via front end system 206. Upon receipt of the required information and commands, or even receipt of the command to begin upload operation 202, the front end system 206 may be configured to indicated or otherwise present available status 208 even while the upload operation is in process in back end system 210. This processing may be desirable or even necessary, as the length of time to process the upload operation 202 may exceed the user's 102 tolerance for delay. A user 102 may desire to engage in one or more additional upload operations 202 with front end 206, even while back end 210 is processing and proceeding with the posting of data and, optionally, providing a posting status 212 to user 102.

Where data is input and output synchronously, the time required to complete the posting operation may be lengthy. Using Ethereum, process 250 may require multiple days. Using Alastria, process 250 may require one or two days. Using Hyperledger, process 250 may require a few hours. Even with asynchronous input and output, the time required to complete the posting operation may be too lengthy for a user 102 to pause other operations. Using Ethereum, process 280 may require half or a full work day. Using Alastria, process 280 may require a few hours. And using Hyperledger, process 280 may require a quarter of an hour or more. A user 102 may not have extra time to wait for such processes 250 and 280 to be completed before moving to the next task or bulk data upload operation 202. Accordingly, back end 210 may be used to manage such operations and provide a posting status 212 while front end 206 provides an available status 208 so that user 102 may continue with other tasks (which may include upload operations) while waiting for the prior upload operation 202 to be completed.

As can be seen in FIG. 2, the exemplary variance in time may be realized based upon synchronous I/O 220 or asynchronous I/O 260 operations. When using synchronous I/O 220, for example, a data posting request 224 is sent and a response 228 is awaited and reported before request 232 is sent. After sending request 232, a response 236 is awaited before sending a next request (not shown). This process can be repeated numerous times. In a different fashion, when using asynchronous I/O 260 operations, a first request 264 is sent, followed by second request 268, and any number of additional requests (not shown) without the need to await a response. Following the sending of request 264, a response 272 will be awaited, although not necessarily idly. Similarly, following the sending of request 268, a response 276 will be awaited. Any number of additional requests (not shown) may be sent without awaiting their corresponding responses (not shown). In this asynchronous I/O 260 operation, while a given response to a request cannot be received before the request is sent, it may be possible for responses to already sent requests to arrive in any order depending on the processing of the requests by the nodes operating the blockchains. As illustrated, first response 272 arrives after both requests and before second response 276. It is possible that second response 276 may arrive before first response 272. It is also possible that first response 272 may arrive before second request 268. However, it is not possible for a response, e.g., 276, to arrive before the corresponding request, e.g., 268. As can be seen, the ability that the invention provides to operate in this asynchronous manner may result in significant computing efficiency and attendant reduction in waiting time.

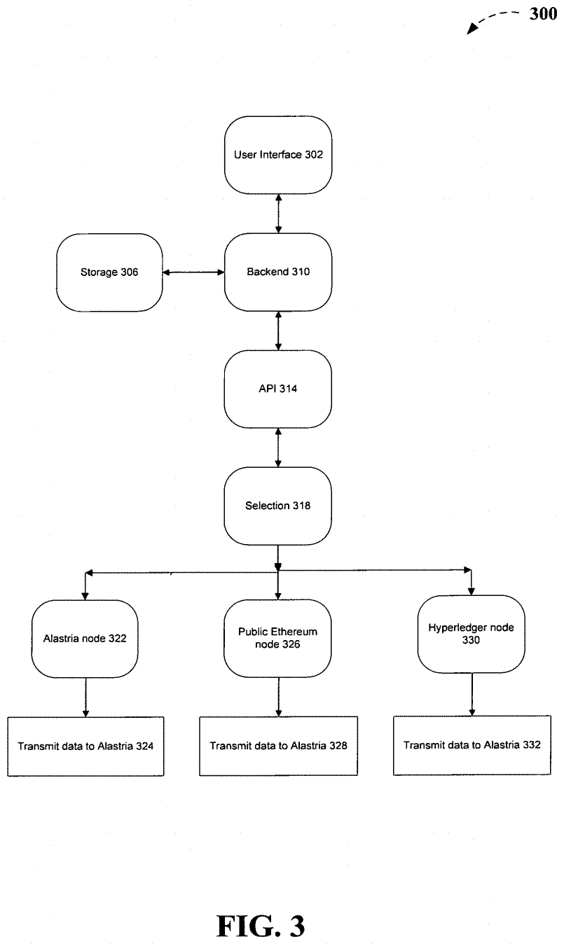

Turning now to FIG. 3, an exemplary block diagram illustrating an embodiment 300 of the functionality of the disclosed inventions is set forth. A user 102 may interact with a computing device 106 through a user interface 302. The user interface may be designed to present information in a user-friendly manner, such as through the use of a programming framework such as Angular or other framework that similarly allows for the presentation of data in a meaningful manner. Such interface 302 may interact, for example, through an application programming interface (API) with backend 310 that may be constructed using Python or similar programming languages. This API may have functionality, including through API calls, that permits interaction through backend 310 with storage 306 and either a direct connection or connection via a second API to block chains. Storage 306 may be a proprietary or internal database that may comprise an offchain storage device or even a non-public blockchain storage device. User 102 may use interface 302 to instruct backend 310 to retrieve data from storage 306 and transmit such data to one or more blockchains, represented in this FIG. by exemplary nodes 322, 326, 330. Backend 310 may retrieve data from storage 306 either before, during, or after establishing a connection to one of nodes 322, 326, 330. In certain systems it may be desirable for backend 310 to interact via API call with an API 314 designed specifically for interaction with various blockchains. In such instances, after data is retrieved from storage 306, it may be partially or fully transmitted via API call from backend 310 to API 314, which may be configured to transmit some or all of the data to one or more of nodes 322, 326, 330. In this example, the desired destinations for the data are reflected by selection 318. Selection 318 does not represent an additional component in the system, but instead represents a selection of the nodes 322, 326, and/or 330 that user 102 indicated via user interface 302. Alternatively, selection 318 may represent a predetermined selection by the institution or a dynamic selection based upon network or blockchain conditions, or another type of logical selection leading to placement of the data on one or more blockchains. Reflecting the selection 318, the data may be transmitted to a node of an Alastria blockchain, identified as node 322. Similarly, the data may be sent to a public Ethereum node 326. Similarly the data may be sent to a hyperledger node 330. Based upon the specific parameters of selection 318, some or all of the data may be sent to any of the three illustrated nodes 322, 326, 330 and/or other nodes (not shown), and divided or duplicated among the nodes as deemed appropriate by the user 102 or other selection mechanism resulting in selection 318. Alastria node 322, or the other nodes, may be located within a server in the same network or computing device being used by user 102 to distribute the data retrieved from storage 306. As illustrated, upon selection 318 reflecting node 322, the data is transmitted in step 324. This transmission may be achieved using software frameworks such as Web3JS, NodeJS, or other appropriate frameworks. In the instance of transmission 328 relating to node 326, the same may be true. With respect to transmission 332 relating to node 330, one may desire to use a NodeJS framework but not a Web3JS framework. As will be recognized by one of skill in the art, a related operation designed to read data from one or more of nodes 322, 326, 330 or other nodes (not shown) and store that data in storage 306 or display that data using interface 302 may be implemented in similar fashion and using a substantially similar system.

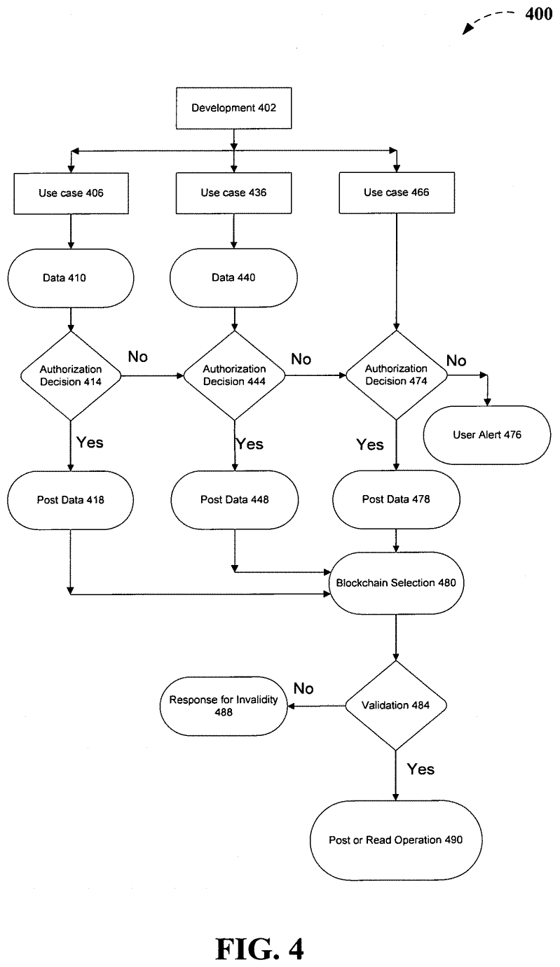

FIG. 4 provides an exemplary indication 400 of the manner in which the inventive system disclosed herein may be implemented. A developer proceeding with development 402 may identify one or more use cases 406, 436, 466 for the data read and write operations for which enhanced efficiency is desired. For example, use case 406 may relate to an education setting in which particular data 410 is preferably stored for later retrieval. For example, in the education setting, data 410 may correspond to a degree recipient identifier, a certificate being received by the recipient, and one or more badges being assigned to the recipient. An alternative use case 436 may correspond to a supply chain system in which data 440 represents information different than that represented by data 410. In the supply chain use case 436, the desired data 440 may include product information and workflow information. Yet another use case 466 might represent a custom API interface. In such cases, data may be unknown during the development 402. However, a specific API interface might be specified such that development 402 can take the API into account. Such cases may be useful where a user, company, institution, etc. desires to implement the inventive methods described herein, but does not wish to provide the developer with an identification of the data or type of data being written or read. In such cases, providing an API may provide for transmission and retrieval of the relevant data without revealing sensitive information during development 402. In each case 406, 436, 466, the system may be developed to require an authorization decision 414, 444, or 474. Such authorization decision may be implemented to monetize or otherwise control access between the user 102 and the posting or retrieval of data from a blockchain. For example, any of authorization decisions 414, 444, or 474 may be programmed to make an inquiry as to whether user 102 has purchase a use plan that permits the desired usage of the system. If the answer to such inquiry in any of 414, 444, or 474 is “No”, then, as indicated, the process may be directed to proceed to user alter 476. User alert 476 may provide an indication directly to a user 102 that the appropriate usage plan has not been purchased or that user 102 should purchase a plan that permits usage of the feature that the user 102 attempted to use. In such manner it may be possible to control flow of data into and out of the system. It may also be possible to provide for monetization of the system beyond initial deployment. Such controls may also be necessary to prevent indiscriminate posting or retrieval of data where each request to post or retrieve data brings actual cost with the request.

On the other hand, if the answer to any of authorization decisions 414, 444, or 474 is “Yes”, the process may proceed to the appropriate post data step 418, 448, or 478. For example, in the education case, post data step 418 may result in the posting of an achievement. In the supply chain case, for example, post data step 448 may result in the posting of activity within a supply chain. In the case of a custom API interface, post data step 478 may result in the posting of a custom data set known to user 102 but not to the developer. The data to be posted in any of steps 418, 448, and 478 may be subjected to a selection step 480, which may correspond closely or identically to selection 318. In implementing this feature, the developer may provide mechanisms by which the user 102 or system selects the appropriate blockchain to which a particular portion or entirety of the data set may be posted. The system may be provided with the functionality to validate 484 blockchains upon selection of one or more blockchains in step 480. In step 484, if a blockchain cannot be validated, the process may proceed to step 488 to provide a response to the user 102 or system that the selected blockchain was not validated. Numerous paths can be taken from this point, both manual and automated. Such steps are not discussed herein, but are anticipated to be within the scope of the inventions disclosed herein. However, if the blockchain is appropriately validated in step 484, the system may be directed to perform the post or read operation 490. In operation 490, data may be posted to and/or read from a validated blockchain or multiple validated blockchains. In some embodiments of the system, a first data item may be posted to or read from a first block chain while the process set forth herein is being repeated with respect to other data or other blockchains. Such blockchains may include, for example, Ethereum, Hyperledger, Alastria, or other blockchains that may be developed.

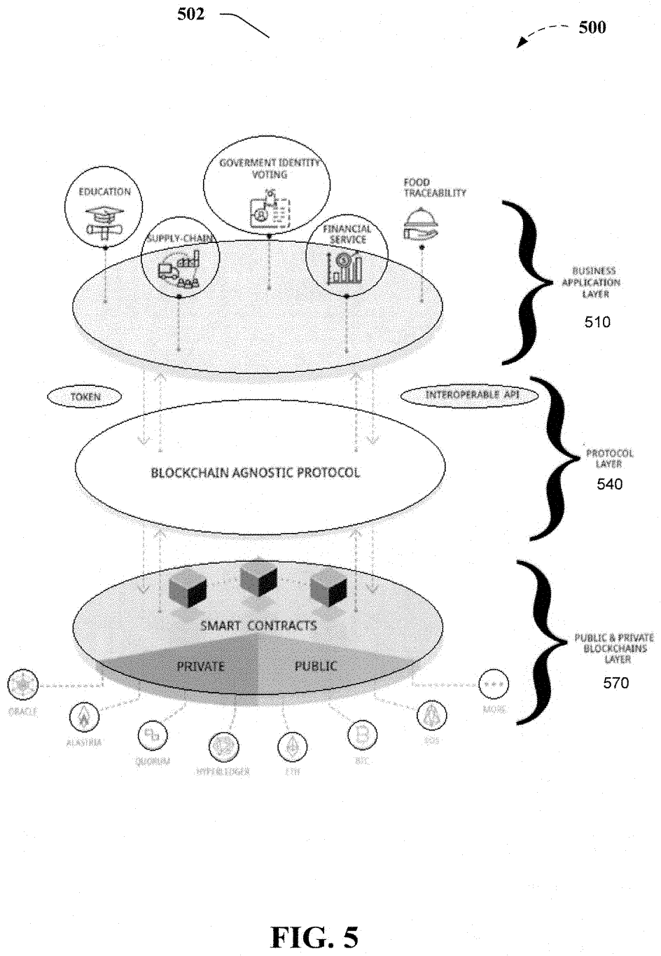

FIG. 5 provides a block diagram of a conceptual framework 500 in which the inventive systems and methods may be utilized. The framework is presented in three layers of functionality, business application layer 510, protocol layer 540, and blockchain layer 570. Business application layer illustrates an exemplary set of potential use cases for the inventive systems and methods, including education, supply chain, government identity/voting, financial service, and food traceability. It is likely that entities operating in each of the use cases presented in business application layer 510 as well as entities in other use cases will have a need to store data upon and retrieve data from a distributed ledger system such as a blockchain.

Exemplary blockchains may be found in public and private blockchain layer 570, and include blockchains identified as Oracle, Alastria, Quorum, Hyperledger, Ethereum (ETH), Bitcoin (BTC), EOS, and others (not shown). While some instances or forks of various blockchains may defy the categorization herein, many of these blockchains represented in layer 570 can be categorized as either private blockchains or public blockchains. Generally private blockchains include Oracle, Alastria, Quorum, and Hyperledger. Generally public blockchains include ETH, BTC, and EOS. Other blockchains (not shown) may fall into either the private or the public category. As illustrated in blockchain layer 570, one or more smart contracts may be associated with many of the identified blockchains, depending upon the definition of the blockchain and the manner in which the smart contract is configured.

In the inventive system, smart contracts specific to a particular user's or use case's needs may be deployed onto any or all of the blockchains relevant to the particular user or use case. Such deployment can be configured to permit the user or use case to post data to each blockchain in a meaningful manner, to similarly retrieve data, or to facilitate both posting and retrieval of data.

The inventive systems and methods may occupy significant portions of the protocol layer 540. As illustrated by the dashed lines with arrows, data may flow between business application layer 510 and blockchain layer 570 in either direction when writing to or reading from blockchains. However, without the identified blockchain agnostic protocol illustrated in protocol layer 540, the manner in which a particular business application communicates may be limited to communication with a particular blockchain. However, the inventive systems and methods provide the ability to define an interaction between a given business application and the protocol in protocol layer 540. Such protocol definition provides a means of sending a receiving data in a manner that is unrelated to transmission to a particular blockchain. Similarly, the communication between protocol layer 540 and blockchains in blockchain layer 570 may be controlled by the protocol such that a subset or all of the blockchains can receive data from and send data to the protocol after verification and through the use of appropriate smart contracts (where needed or desired). Accordingly, while the exemplary financial service application of layer 510 might be configured to send and receive data from the Ethereum blockchain in layer 570, through use of the inventive systems and methods employed in part in layer 540, the exemplary financial service application may be able to send data to or receive data from a larger subset or even all of the identified blockchains without significant modification of the financial service application.

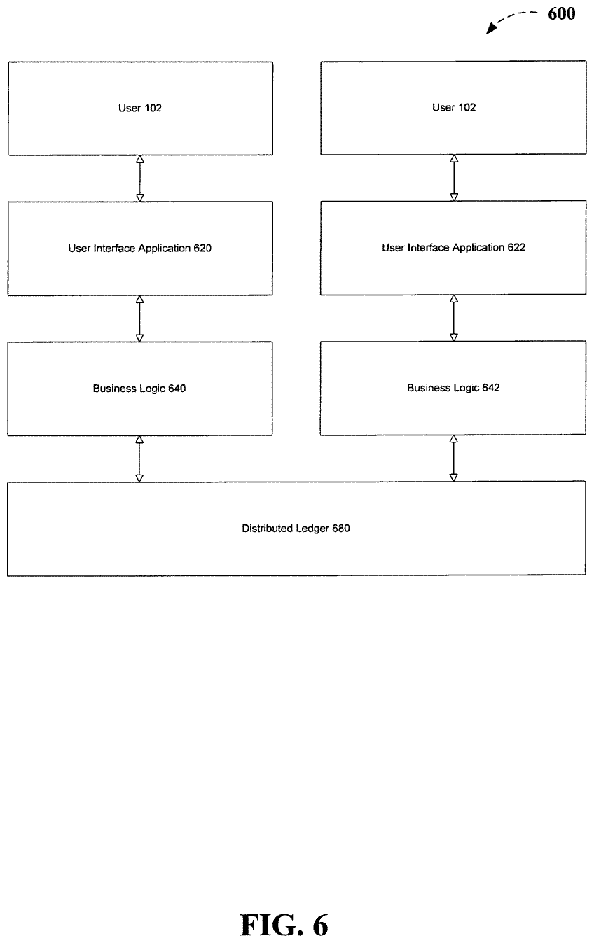

FIG. 6 provides a block diagram of an exemplary embodiment 600 of the inventive systems and methods. One or more users designated 102, but shown separately to indicate the possibility of multiple such users, may interact with the user interface of a user interface application 620, 622. Such applications may be similar or different depending on the application and also potentially depending on the entity or institution with which user 102 is affiliated. In this exemplary embodiment, applications 620 and 622 are used by different users 102 to send data to and retrieve data from distributed ledgers 680 such as blockchains. Blockchains represented by ledger 680 may be public or private blockchains. Because each application 620 or 622 may be different and each distributed ledger 680 (illustrated as a single block, but representing two or more such ledgers) may have different protocols, yet it may be desirable to post data from one or more applications to multiple ledgers or to retrieve data from multiple ledgers by one or more applications. Based upon this, business logic 640 may provide an interface between application 620 and any of the blockchains represented by ledger 680. Similarly, business logic 642 may provide an interface between application 622 and any of the blockchains represented by ledger 680. Business logic 640, 642 may include APIs, NLP, smart contracts, and other appropriate logic to be used in appropriately packaging data for posting upon multiple blockchains or unpacking data retrieved from multiple blockchains. In certain embodiments, it may be desirable for user interface application 622 to request data from one or more blockchains such that business logic 640, 642 retrieves the data and distributes some or all of the data to application 622 while also distributing some or all of the data to application 620. For example, where a potential employer is operating application 620, a job applicant may be using application 622. In this example, the job applicant may used application 622 to request that credential information with detailing underlying data be sent to potential employer via application 620, with a confirmation sent to application 622. The business logic 640, 642 may retrieve the detailed information underlying multiple credentials to application 620, while sending a confirmation that may consist only of sample or partial information to application 622 so that the potential job applicant can confirm that all relevant credentials and/or no irrelevant credentials were retrieved and sent to application 620.

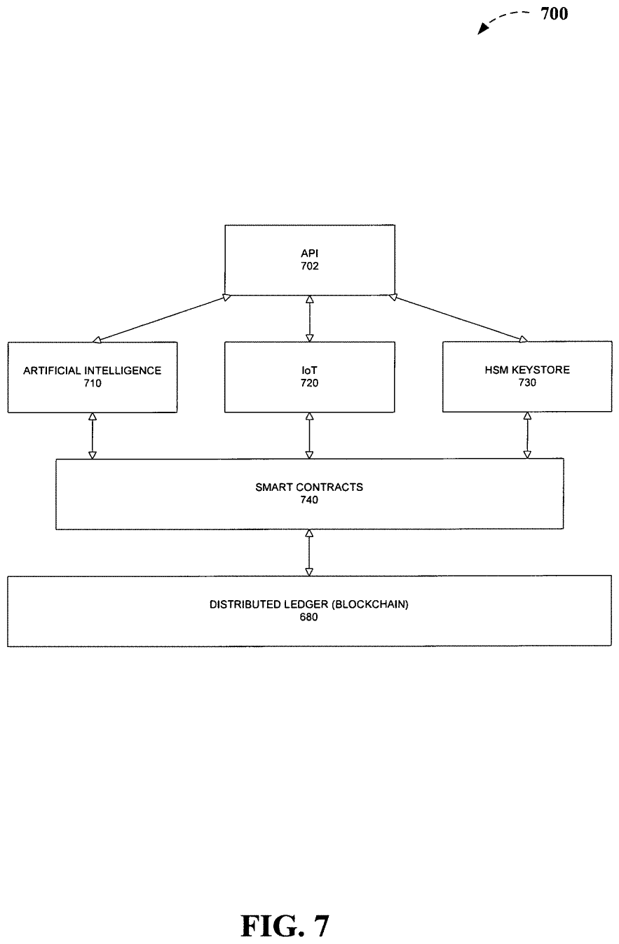

FIG. 7 illustrates a block diagram of an exemplary set of business logic 700 in an exemplary embodiment of the inventive systems and methods. API 702 may serve as the logical interface between user applications and other business logic, receiving data from such applications as well as instructions regarding the manner in which the data should be processed and/or returning data to such applications and potentially information regarding results of prior instructions or inquiries. Upon receipt of data and an appropriate instruction, API 702 may send such data and/or instructions to one or more of artificial intelligence (AI) 710, internet of things (IoT) 720, and hardware security module (HSM) keystore 730. Instructions to AI 710 may request processing of certain data before transmitting such data to smart contracts 740. Alternatively, instructions to AI 710 may request retrieval of information via smart contracts 740 for further processing by AI 710 prior to returning such data or the results of processing such data to API 702. Instructions to IoT 720 may request that a physical item in IoT 720 perform a task and transmit the result of such task to smart contracts 740. For example, in an inventory process, API 702 may request that a sensor in IoT 720 make a recording of what it senses (e.g., weight or light or another indication that may indicate the presence, absence, quantity, etc. of an item to be inventoried) and transmit the result to smart contracts 740. Alternatively, instructions to IoT 720 may instruct IoT 720 to use smart contracts 740 to retrieve data from ledger 680 and, based on the contents of such data, perform a task prior to returning the results of the task, the data, or a set of data combining the retrieved data and the results of the task. For example, in the financial services industry, predictions regarding vacation company stock prices may be returned, coupled with a weather reading by IoT 720 that may help to predict whether a hurricane is expected near the company's real estate, and then sent to API 702 for combined processing and return to user 102. Likewise, API 702 may send data or instructions to HSM keystore 730 to provide a digital key to one or more smart contracts 740 for use in retrieving information from ledger 680. Or, as another example, API 702 may instruct keystore 730 to check data returned by smart contracts 740 from ledger 680 and confirm whether the data matches an appropriate key or item in HSM keystore 730 before reporting the result to API 702. As illustrated, smart contracts 740 may operate as a logical interface with ledger 680. In blockchains where such smart contracts 740 are not permitted the inventive system may be implemented without the use of smart contracts 740 and with direct connections that logically connect API 702, AI 710, IoT 720, HSM keystore 730, and/or other business logic (not shown) to the ledger 680.

For use with the inventive system, public and private keys may be generated and/or used in various manners. For example, for use with Ethereum, a 42 character public key may be generated and used along with a 64 character private key that is maintained confidentially. Both keys may be stored in the inventive system either in HSM keystore 730 or another appropriate location within the system. Such keys may be accessed via API or other software when a user 102 attempts to access an Ethereum blockchain to post or retrieve data.

With respect to Alastria, a private blockchain such as this may have multiple public keys. One such key may be a random identifiable 32 character key that may be generated by the inventive system to access a public key that is present in a private node of the blockchain. A public key may be stored in the inventive system and the private key may also be stored in the HSM keystore 730 or another appropriate location within the system.

Regarding Hyperledger blockchains, multiple public keys may be generated. One may be a random identifiable 32 character key generated by the inventive system to access another public key that is preferably present in a private node of the blockchain. This public key may be stored in the HSM keystore 730 or another suitable location within the inventive system. A private key may also be generated and stored in a secure location such as within the private node of the blockchain.

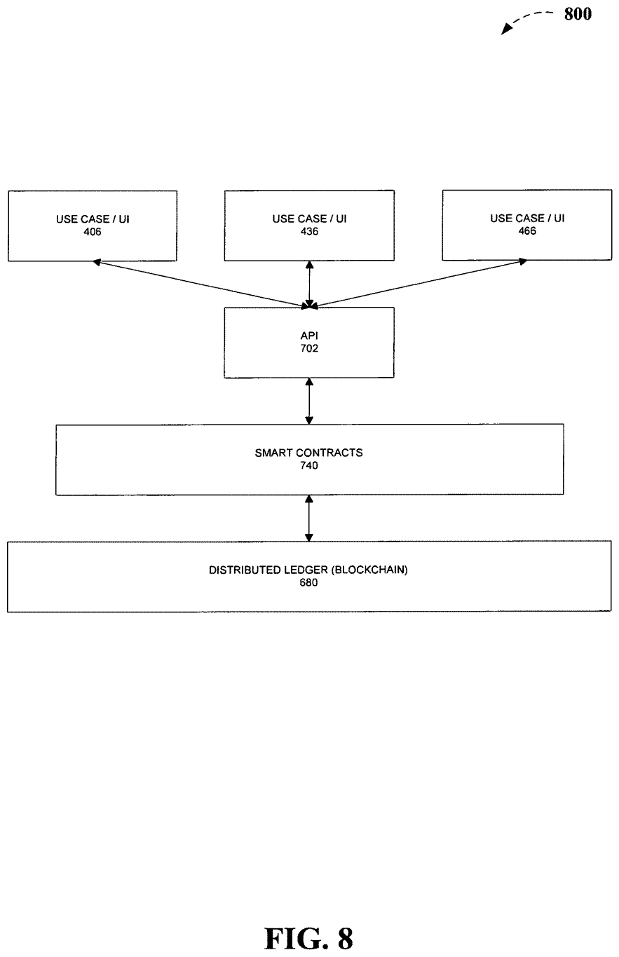

FIG. 8 provides a block diagram 800 similar to FIG. 7, illustrating an embodiment of the inventive system to highlight the application layer. As illustrated, one, two, three, or many use cases, for example, use cases 406, 436, 466 may incorporate user interface software such as user interface 302 to interact with API 702 for posting and/or retrieving data from ledger 680 or information based upon such data. As illustrated, API 702 may receive data and/or instructions directly from use cases 406, 436, 466 and transmit that data directly to smart contracts 740 that interact with distributed ledger 680. In the alternative, as illustrated in FIG. 7, various other business logic may be incorporated with API 702 and even placed logically between API 702 and smart contracts 740. In another alternative, API 702 may communicate directly with the some or all of the blockchains represented by ledger 680 without the need for smart contracts 740. Operations may be the same as are described above and below.

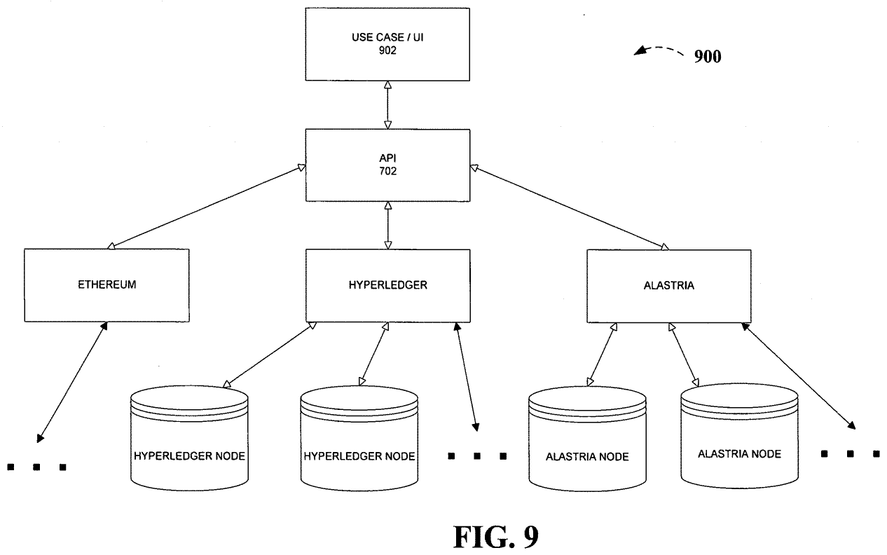

Referring to FIG. 9, the block diagram illustrates an exemplary system 900 in accord with an embodiment of the invention. Use case 902 may correspond to one or more of use cases 406, 436, 466, or another not yet illustrated use case. Such use cases may correspond to any of those identified in application layer 510 or others. A user 102 interacting with user interface software relating to use case 902 (which may correspond to any of the use cases shown in layer 510, any of use cases 406, 436, 466, or other use cases) may interact with API 702 with respect to the posting to and/or retrieval of information from multiple blockchains such as Ethereum, Hyperledger, Alastria, or others including those illustrated in FIG. 5 or other blockchains (not shown). As depicted, API 702 may contact multiple block chains for posting or retrieval of data, and may contact any one of many nodes of such blockchains for the posting or retrieval of data. API 702 may interact with blockchains via smart contracts (not shown) or directly. In this FIG., a Hyperledger blockchain is illustrated with two nodes depicted and additional nodes referenced via ellipses. Similarly, an Alastria blockchain is illustrated with two nodes depicted and additional nodes referenced via ellipses. And an Ethereum blockchain is illustrated without any nodes depicted, but with an ellipses indicating multiple nodes. Use case 902 may comprise any of many types of software suitable for user interface and communication purposes, such as Angular, SAP, mobile applications, etc. API 702 may incorporate a library and may be programmed using Python, NodeJS, Web3JS, PostgreSQL, or other appropriate frameworks.

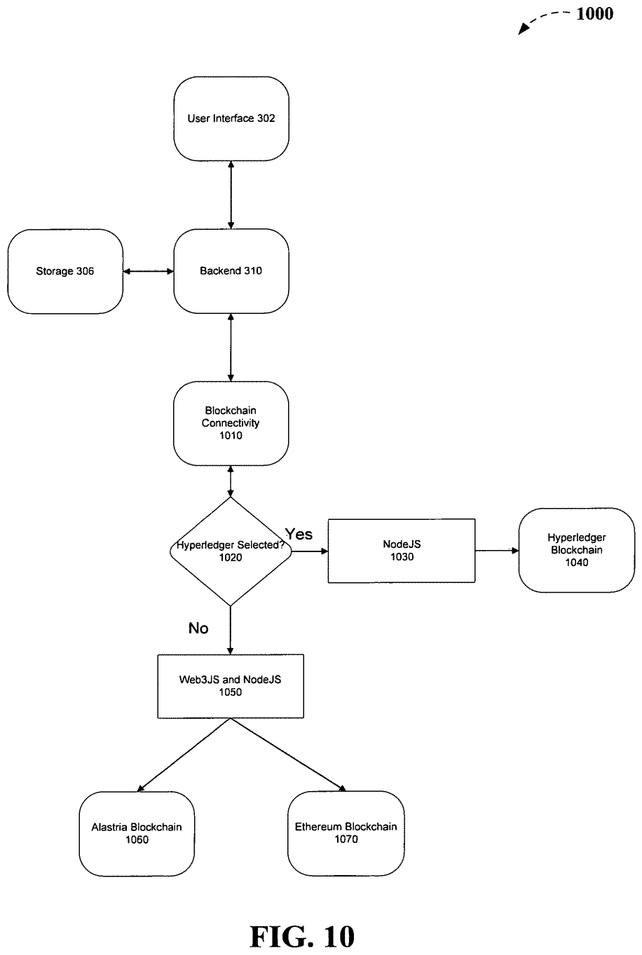

FIG. 10 presents a block diagram representing a process flow 1000 in an exemplary embodiment of the inventive system and methods. User interface 302 may comprise a frontend system constructed using Angular or other appropriate frameworks. Storage 306 may comprise a PostgreSQL database or another appropriate database structure. Backend 310 may comprise Python software or software written in an appropriate software language. Blockchain connectivity 1010 corresponds roughtly to API 314. Blockchain connectivity 1010 can refer to the software and other logic used to determine, validate, and connect to an appropriate blockchain such as Alastria 1060, Ethereum 1070, or Hyperledger 1040 for posting or retrieving information. The logical step 1020 indicates that if the interaction is to be with a Hyperledger blockchain 1040, then the NodeJS framework 1030 is preferably used for the interaction. Whereas, if the interaction is to be with an Alastria blockchain 1060 and/or an Ethereum blockchain 1070, then the Web3JS and NodeJS frameworks 1050 are both preferably used for the interaction. Data may be posted and retrieved as discussed throughout this disclosure.

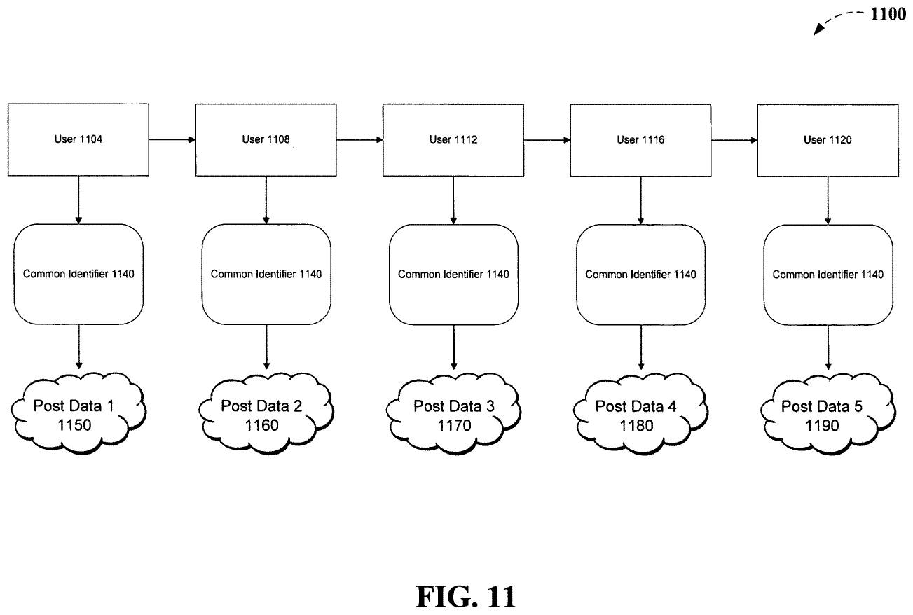

FIG. 11 shows a block diagram of an illustrative exemplary embodiment 1100 of the inventive system and method with respect to the posting of data to a blockchain. As illustrated, a set of data established with a common identifier may be distributed among multiple distributed ledgers by multiple users, yet relate to a single item, concept, or related construct to be related within data without the need to return to each of the users to confirm the identity. In this example, User 1104 may affix common identifier 1140 to data before posting the data to a distributed ledger 1150. User 1108 may also affix the same common identifier 1140 to that user's data before posting the data to a distributed ledger 1160. Each of Users 1112, 1116, and 1120 may affix common identifier 1140 their respective data before respectively posting their data to distributed ledgers 1170, 1180, 1190.

For example, when tracking a medicine, a user 1104 may post information indicating that the medicine has been manufactured to a first blockchain 1150, with an identifier, for example “batch #THX1138” as its identifier 1140. Upon shipment of the medicine, user 1108 may represent the shipper who posts to another blockchain 1160 that Batch THX1138 has been shipped by incorporating common identifier 1140 in the post. When the medicine is received at a warehouse, user 1112 may represent the warehouse operator and post in one of the previously used blockchains or yet another blockchain that the Batch THX1138 has been stored by incorporating common identifier 1140. The operator shipping the medicine from the warehouse to a pharmacy, e.g. user 1116, may post in a blockchain (either a previously used blockchain or another) that Batch THX1138 has been shipped to a pharmacy and indicate as much by incorporating common identifier 1140 in the data. Finally, in this example, the pharmacist, e.g., user 1120, may post to one of the previously used blockchain or another blockchain that the Batch THX1138 was sold to a particular customer or sold on a particular day. In this example, it is conceivable that first post operation 1150 was to an Alastria blockchain, second post operation 1160 was to a Hyperledger blockchain, third post operation 1170 was again to an Alastria blockchain, fourth post operation 1180 was again to a Hyperledger blockchain, and fifth post operation 1190 was to an Ethereum blockchain.

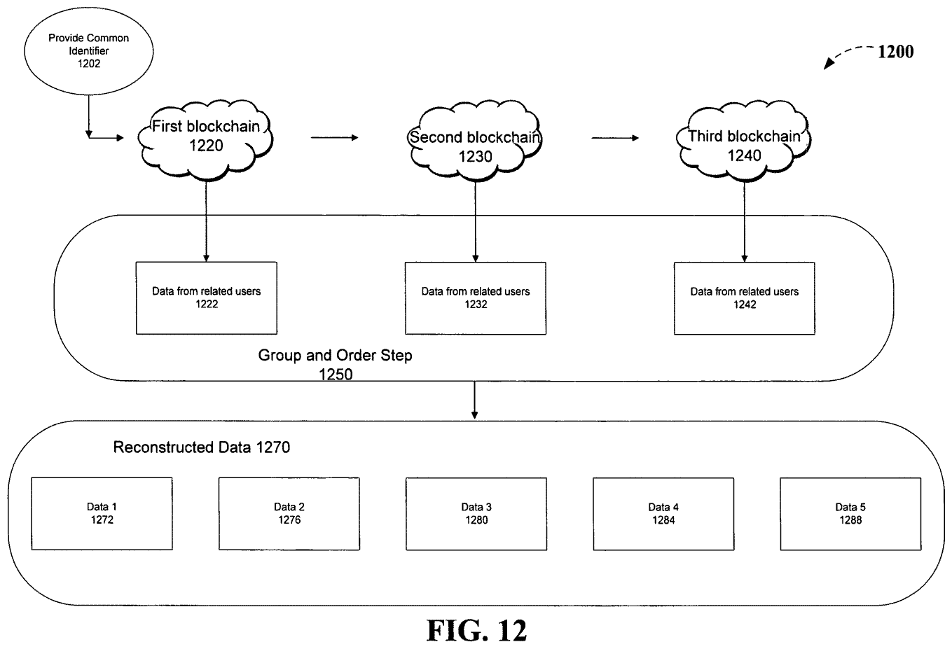

FIG. 12 shows a block diagram of an illustrative exemplary embodiment 1200 of the inventive system and method with respect to the retrieval and reconstruction of data by a user 102. In this exemplary embodiment of data retrieval, a user 102 may desire to retrieve data from multiple blockchains, while the user 102 does not have a user interface program 302 that is capable of extracting data from multiple blockchains or compiling the data in a meaningful manner after such extraction. In such a case, the systems and methods provided via protocol layer 540, including API 702, associated business logic including smart contracts, and the validation procedure of the inventive systems and methods permits such retrieval. User 102 may provide a common identifier 1140 in step 1202 to API 702 for retrieval of information identified by this common identifier. API 702 may then pose inquiries to each of blockchains 1220, 1230, 1240, and/or any blockchains to which API 702 has access and connection ability and for which either user 102 or other logical processes have indicated that data retrieval is desirable. In the preceding example, data regarding the medicine was posted to an Alastria blockchain in operations 1150 and 1170. Thus, assuming that first blockchain 1220 is Alastria, the common identifier THX1138 is provided in step 1202, and API 702 was able to validate the use of Alastria blockchain, data 1222 is expected to contain the data posted in operations 1150 and 1170. With similar assumptions except assuming that the second blockchain 1230 is Hyperledger, then data 1232 is expected to contain the data posted in operations 1160 and 1180. Retaining the same assumptions except assuming that the third blockchain is Ethereum, then data 1242 is expected to contain the data posted in operation 1190.

Such data 1222, 1232, 1242 may be unordered, formatted with variations attributable to different users 1104, 1108, 1112, 1116, 1120, or others, and/or otherwise arranged in a manner that will be difficult for user 102 to use. Thus, in step 1250, protocol layer 540, business logic 640, 642, AI 710, IoT 720, HSM keystore 730, or other appropriate logic may be used to group and order the data in a manner that is useful to user 102 or the software deployed on behalf of user 102. This ordered data is represented by reconstructed data 1270 in which Data 1 1272, Data 2 1276, Data 3 1280, Data 4 1284, and Data 5 1288 are presented in order of the posting operations. With respect to the medicine example cited above for the batch with common identifier 1140 set as THX1138, Data 1 1272 represents the manufacture, Data 2 1276 represents the first shipment, Data 3 1280 represents the warehousing, Data 4 1284 represents the second shipment, and Data 5 1288 represents the pharmacist's sale.

Multiple common identifiers may be employed such that certain common identifiers are assigned to portions of a data transaction while other common identifiers are assigned to different portions of a data transaction so that users who have desire or authorization to access certain data may be permitted to or restricted from accessing other data. For example, in the preceding medicine example, a person using the medicine purchased from the pharmacist may be permitted to view the data related to dates of manufacture, shipping, storage, second shipping, and sale. However, that person may not be permitted to view the data related to the location of the warehouse, the company performing the shipping, or other restricted information, while the manufacturer of the medicine might require access to such information for liability or other purposes. Thus, a second common identifier known to the manufacturer but not the pharmacist or person using the medicine could be attached to certain information in the chain. This example might be extended further if the manufacturer packed the medicine on a particular pallet that had a common identifier and the pallet was used for the shipping and warehousing stages, but the pallet was removed and send in another direction before the second shipping stage. In such instance, the pallet may be loaded with additional cargo unrelated to the initial medicine, but a user in the chain may desire to track that pallet for a business purpose. Thus, the pallet may be assigned yet another common identifier so that certain parties can track the life, location, etc. of the pallet. But the person using the medicine might not be permitted to access such information. Accordingly another common identifier other than THX1138 may be affixed to transactions involving the pallet, whether or not the medicine was involved. Later, a user analyzing data related to the pallet might use pallet-related common identifier to track the pallet data while being restricted from gaining information about the pharmacist or the user who purchased the medicine. Thus, within the inventive systems it may be desirable to use multiple common identifiers.

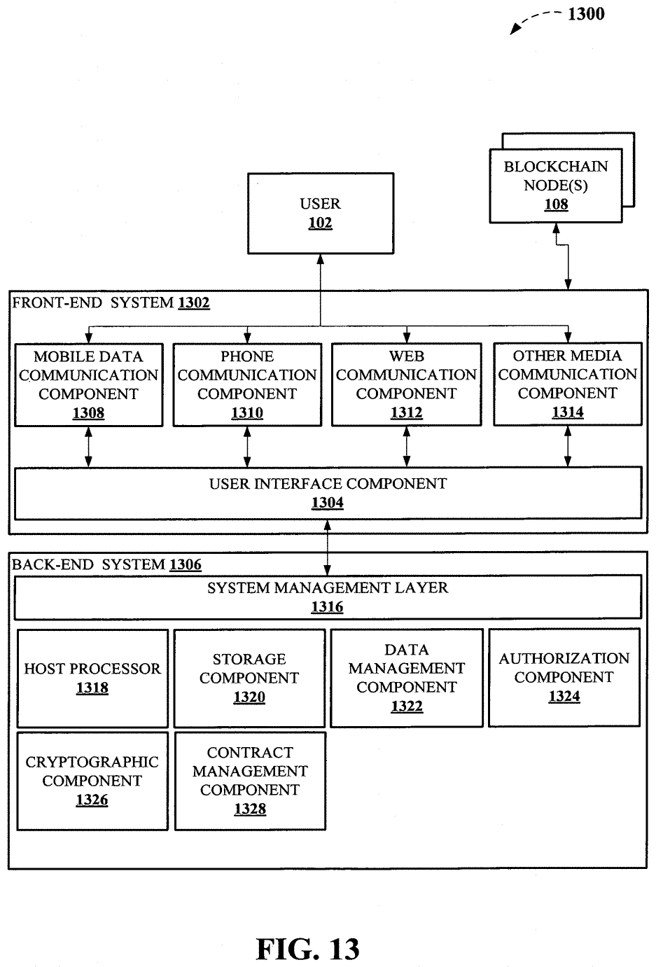

FIG. 13 depicts a functional block diagram illustrating exemplary non-limiting devices or systems suitable for use with aspects of the disclosed subject matter. For instance, FIG. 13 illustrates exemplary non-limiting devices or systems 1300 suitable for performing various aspects of the disclosed subject matter in accordance with the systems and methods disclosed herein. For example, as described above regarding FIG. 1, a user 102 can interact with a blockchain node 108 via a front-end system 1302 that can comprise or be associated with one or more communication components and/or one or more user interface components 1304. As further described herein, user 102 interactions with node 108 can be further processed and/or handled via a back-end system 1306 that can also comprise or be associated with system management layer 1316 and/or one or more system components. As depicted in FIG. 13, the inventive system may comprise a front-end system 1302 that can, in turn, comprise one or more of mobile data communication component 1308, phone communication component 1310, web communication component 1312, and/or other media communication component 1314, etc. As further depicted in FIG. 13, the inventive system can comprise a back-end system 1306 that can, in turn, comprise one or more of host processor 1318, storage component 1320, data management component 1322, authorization component 1324, cryptographic component 1326, contract management component 1328, etc., either as described above, or as further described herein.

Thus, FIG. 13 illustrates an exemplary non-limiting device or system 1300 suitable for performing various aspects of the disclosed subject matter regarding the posting, retrieval, and use of data, as well as the validation, the verification, the authentication, and the proper protection and control of such user data, to ensure smooth, efficient, and cost-effective business processes, and therefore, in turn, attractive prices on the offered goods and services in accordance with the various non-limiting embodiments as described herein.

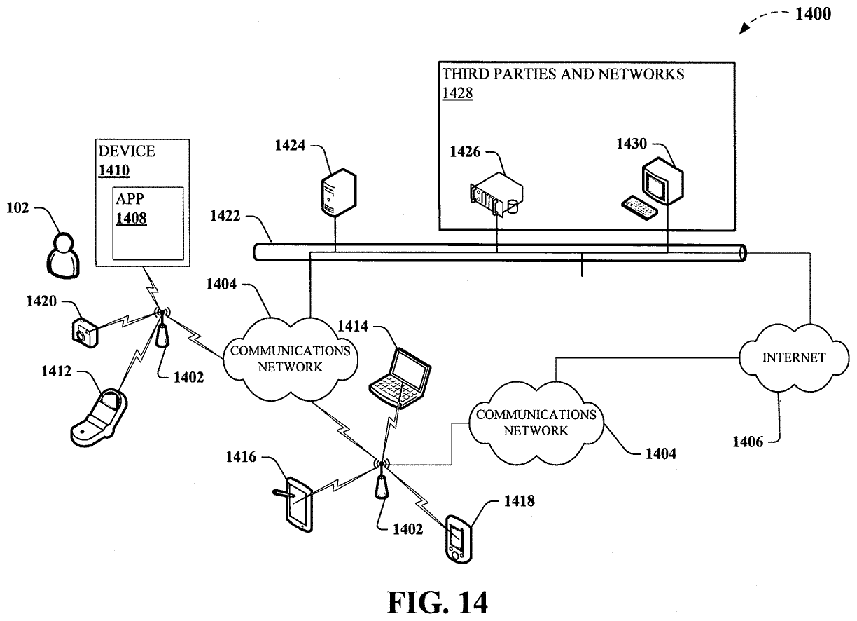

For instance, as described below with reference to FIG. 14, for example, various non-limiting embodiments of the disclosed subject matter can comprise more or less functionality than those exemplary devices or systems described therein, depending on the context. In addition, a device or system 1300 as described can be any of the devices and/or systems as the context requires and as further described above in connection with FIGS. 1-12. It can be understood that while the functionality of device or system 1300 is described in a general sense, more or less of the described functionality may be implemented, combined, and/or distributed (e.g., among network components, servers, databases, and the like), according to context, system design considerations, and/or marketing factors, and the like. For the purposes of illustration and not limitation, exemplary non-limiting devices or systems 1300 can comprise one or more exemplary devices and/or systems of FIG. 14, such as device 1410, computing system 1426, computing system 1430, etc., as described below, for example, or portions thereof.

Referring again to FIG. 13, computing device 106 comprising device or system 1300, or portions thereof, can also include a user interface component 1304, which can be associated with one or more host processors 1318, and which can facilitate various aspects of the disclosed subject matter. For instance, user interface component 1304 can provide various types of user interfaces to facilitate interaction between a user 102 (e.g., user 102, a device on behalf of user 102, an appropriately configured application, or app, such as an app appropriately configured for a specific device, such as described below with reference to FIGS. 14-19) and any component coupled to, or associated with, one or more host processors 1318, computing device 106, and so on, for example, such as described below with reference to FIGS. 14-19, etc. In addition to being configured or adapted to be accessed by one or more user 102, user interface component 1304, can be further configured to provide one or more GUIs, command line interfaces (CLIs), machine accessible interfaces (e.g., APIs such as e-commerce and/or MIS back-end interfaces), structured and/or customized menus, and the like. In yet another exemplary implementation, user interface component 1304 can facilitate interaction between a user 102 (e.g., via a device associated with user 102, etc.), such as between a mobile device native app installed directly onto the device (e.g., smartphone, tablet, etc.) coded in its own native programming language, and/or a mobile web app (e.g., an Internet-enabled app, etc.) that has specific functionality for mobile devices and accessed through the mobile device's web browser, as further described herein.

For example, an exemplary computing device 106 comprising user interface component 1304 can facilitate rendering a GUI that can provide user 102 with a region (e.g., region of a device screen, such as via an operating system (OS), application, or otherwise, etc.) or other means to load, import, read, etc., data and/or information, and/or can include a region to present results output from API 702 and/or various blockchains. These regions can comprise known text and/or graphic regions comprising dialogue boxes, static controls, drop-down-menus, list boxes, pop-up menus, edit controls, combo boxes, radio buttons, check boxes, push buttons, and/or graphic boxes, and the like. In addition, utilities to facilitate the presentation such as vertical and/or horizontal scroll bars for navigation and toolbar buttons to determine whether a region will be viewable can be employed. For example, user 102 can interact with one or more of the components depicted in FIG. 13, for instance, whether associated with, coupled to, and/or incorporated in one or more host processors 1318 associated with computing device 106, and so on.

Computing device 106 comprising user interface component 1304 can facilitate user 102 interaction with such regions to select and/or provide information via various devices such as a mouse, a roller ball, a keypad, a keyboard, touchpad, touch screen, a pen and/or voice activation, for example. Typically, a mechanism such as a push button or the enter key on the keyboard can be employed to facilitate entering information in a device associated with user 102 to facilitate interaction with device 106 comprising device or system 1300, or portions thereof. However, it is to be understood that the claimed subject matter is not so limited. In a non-limiting example, merely highlighting a check box can initiate information conveyance.

In yet another example, a command line interface (CLI) can be employed. For example, the command line interface can prompt (e.g., via a text message on a display and/or an audio tone, etc.) user 102 for information via providing a text message. Thus, user 102 can provide suitable information, such as alpha-numeric input corresponding to an option provided in the interface prompt or an answer to a question posed in the prompt. It is to be understood that a command line interface can be employed in connection with a GUI and/or API. In addition, the command line interface can be employed in connection with hardware (e.g., video cards of a computer) and/or displays (e.g., black and white, EGA, or other video display unit of a standalone device such as an LCD display on a network capable device) with limited graphic support, and/or low bandwidth communication channels. As a further example, a device associated with user 102 that facilitates interaction with device 106 comprising device or system 1300 can include one or more motion sensors and associated software components, voice activation components, and/or facial recognition components that can be used by a user to facilitate entering information into device 106 comprising device or system 1300, or portions thereof.

Referring again to FIG. 13, in further exemplary implementations, device 106 can comprise one or more system management layers 1330 that can facilitate management of one or more system components, as further described herein, and/or one or more components associated with user interface component 1304, one or more communications components, and so on, for example, via computer-executable instructions executing on one or more host processors 1318, or otherwise. In a non-limiting example of an exemplary device 106, one or more system components can comprise one or more of storage component 1320, data management component 1322, authorization component 1324, cryptographic component 1326, contract management component 1328, etc., without limitation. In addition to being configured or adapted to facilitate management of one or more of system components, and so on, system management layer 1316, can be further configured to manage and/or provide one or more interfaces such as one or more CLIs, machine accessible interfaces (e.g., APIs such as e-commerce and/or MIS back-end interfaces), and the like, whether in lieu of, in addition to, and/or complementary to any such interfaces provided by user interface component 1304 or other components associated device 106.

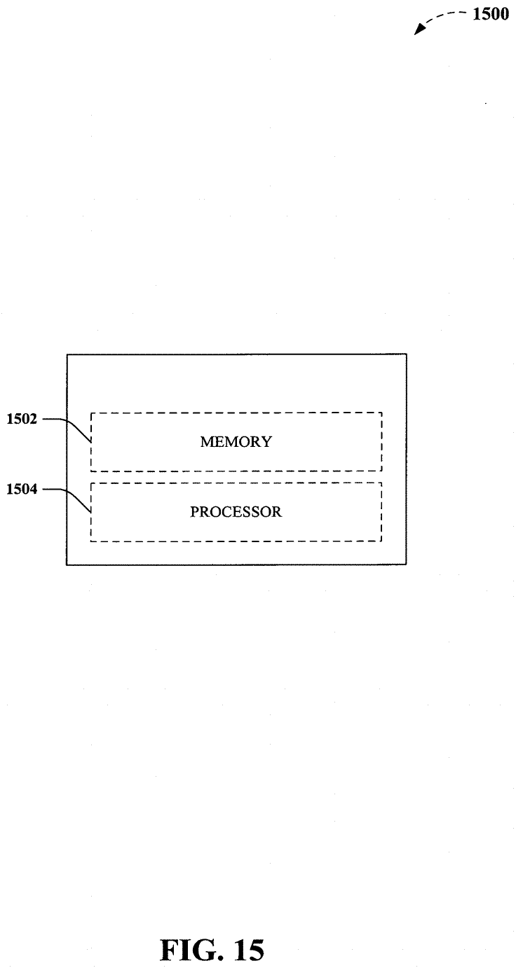

In yet another non-limiting embodiment, exemplary device 106 can comprise or be associated with a storage component 1320 configured to store machine-executable code associated with data posting and/or retrieval, for example, as further described herein, regarding FIGS. 15-19.

It can be understood that any of storage component 1320, data management component 1322, authorization component 1324, cryptographic component 1326, or contract management component 1328 can comprise one or more of system components, and/or portions thereof, to facilitate any of the functionality described herein and/or ancillary thereto, such as by execution of computer-executable instructions by a computer, a processor, etc. (e.g., one or more of host processors 1318, processor 1504, etc.). Moreover, any of the components described herein (e.g., storage component 1320, etc.) can be configured to perform the described functionality (e.g., via computer-executable instructions stored in a tangible computer readable medium, and/or executed by a computer, a processor, etc.).

Cryptographic component 1326 can facilitate securing data and/or information being written to, stored in, and/or read from the storage component 1320 (e.g., account and/or profile information, messages, queries, requests, responses, etc.), transmitted to and/or received from a connected network (e.g., such as for transmitting user 102 and/or associated device information to node 108, etc.), and/or creating a secure communication channel as part of a secure association of various devices with exemplary implementations of the inventive system comprising non-limiting embodiments of devices or systems 1300, or portions thereof, with a user 102 (or one or more of third parties) facilitating various aspects of the disclosed subject matter to ensure that protected data can only be accessed by those entities authorized and/or authenticated to do so. To the same ends, cryptographic component 1326 can also provide asymmetric cryptographic accelerators and tools (e.g., RSA, Digital Signature Standard (DSS), and the like) in addition to accelerators and tools (e.g., Secure Hash Algorithm (SHA) and its variants such as, for example, SHA-0, SHA-1, SHA-224, SHA-256, SHA-384, SHA-512, SHA-3, and so on). As described, any of the components described herein (e.g., cryptographic component 1326, etc.) can be configured to perform the described functionality (e.g., via computer-executable instructions stored in a tangible computer readable medium, and/or executed by a computer, a processor, etc.).

It should be noted that, as depicted in FIG. 13, devices or systems 1300 are described as monolithic devices or systems. However, it is to be understood that the various components and/or the functionality provided thereby can be incorporated into one or more host processors 1318 or provided by one or more other connected devices. Accordingly, it is to be understood that more or less of the described functionality may be implemented, combined, and/or distributed (e.g., among network devices or systems, servers, databases, and the like), according to context, system design considerations, and/or marketing factors. Moreover, any of the components described herein can be configured to perform the described functionality (e.g., via computer-executable instructions stored in a tangible computer readable medium, and/or executed by a computer, a processor, etc.).

Accordingly, non-limiting embodiments of exemplary devices or systems 1300 can comprise or be associated with a processor and a memory that stores computer executable components that, when executed by the processor, facilitate performance of operations, wherein the computer executable components can comprise a storage component 1320 configured to store data associated with a user (e.g., user 102) in a distributed file system (DFS), for example, as further described herein.

FIG. 14 illustrates an overview of an exemplary computing environment 1400 suitable for incorporation of embodiments of the disclosed subject matter. For example, computing environment 1400 can comprise wired communication environments, wireless communication environments, and so on. As a further example, computing environment 1400 can further comprise one or more of a wireless access component 1402, communications networks 1404, the Internet 1406, etc., with which a user 102 can employ any of a variety of devices (e.g., device 1410, devices 1412-1420, and so on) comprising an appropriately configured application, or app 1408 (e.g., such as via an app appropriately configured for a specific device associated with user 102, such as described below), or other functionality (e.g., browsers, clients, etc.) to communicate data and/or information over a communication medium (e.g., a wired medium 1422, a wireless medium via wireless access component 1402, etc.) according to an agreed protocol, to facilitate communication of data and/or information associated one or more users and/or computing systems or devices associated therewith, such as device 1410, computing systems or devices 1424, 1426, and 1430, respectively (e.g., via an operating system, application software, device drivers, communications stacks, etc., which can perform such actions on behalf of such computing systems or devices). For instance, user interface component 1306 can facilitate interaction between a user 102 (e.g., via a device associated with user 102, and so on, etc.), such as via a mobile device native app installed directly onto the device (e.g., smartphone, tablet, etc.) coded in its own native program language, and/or via a mobile web app (e.g., an Internet-enabled app, etc.) that has specific functionality for mobile devices and/or accessed through the mobile device's web browser, as described herein.

Thus, as described herein, in various non-limiting aspects, devices 1410 (e.g., comprising app 1408, or otherwise, and so on, etc.) employed in connection with the inventive systems and methods can facilitate various actions described herein regarding FIGS. 1-19, for example.

Accordingly, computing environment 1400 can comprise a number of components to facilitate described functionalities according to various aspects of the disclosed subject matter, among other related functions. While various embodiments are described with respect to the components of computing environment 1400 and the further embodiments more fully described herein, one having ordinary skill in the art would recognize that various modifications could be made without departing from the spirit of the disclosed subject matter. Thus, it can be understood that the description herein is but one of many embodiments that may be possible while keeping within the scope of the claims appended hereto.

Additionally, while device 1410 is shown as a generic network capable device, which can include any of a variety of devices (e.g., device 1410, devices 1412-1420, and so on), device 1410 is intended to refer to a class of network capable devices that can one or more of receive, transmit, store, etc., data and or information incident to and that user 102 and/or third parties and networks 1428 (e.g., one or more of third parties) can employ to facilitate various techniques of the disclosed subject matter. However, the discussion of the foregoing distinction is intended for illustration and not limitation. While for purposes of illustration, user 102 is described as performing certain actions, it is to be understood that device 1410 (e.g., via an operating system, application software, device drivers, communications stacks, etc.) can perform such actions on behalf of user 102, as further described herein. Similarly for third parties and networks 1428, which can be discussed or described as performing certain actions, it is to be understood that computing systems or devices (e.g., 1426, 1430) associated with third parties and networks 1428, respectively (e.g., via an operating system, application software, device drivers, communications stacks, etc.) can perform such actions on behalf of third parties and networks 1428, respectively.

Accordingly, exemplary device 1410 can include, without limitation, a cellular phone 1412, a laptop computer 1414, a tablet personal computer (PC) device 1416, and/or a personal digital assistant (PDA) 1418, or other mobile device, and so on connected to a network via access component 1402 or otherwise. As further examples, device 1410 can include such devices as a network capable camera 1420 and other such devices (not shown) as a pen computing device, wearable computing device, portable digital music player, home entertainment devices, network capable devices, appliances, kiosks, and sensors, and so on. It is to be understood that device 1410 can comprise more or less functionality than those exemplary devices described above as the context requires and as further described herein.

According to various embodiments of the disclosed subject matter, device 1410 can connect to other devices to facilitate accomplishing various functions as further described herein (e.g., posting or retrieving data). In addition, device 1410 can connect via one or more communications networks 1404 to a wired network 1422 (e.g., directly, via the Internet 1406, or otherwise). Wired network 1422 (as well as communications network 1404) can comprise any number of computers, servers, intermediate network devices, and the like to facilitate various functions as further described herein. As a non-limiting example, wired network 1422 can include and/or be associated with computing systems or devices 1426 (e.g., one or more appropriately configured computing devices associated with, operated by, or operated on behalf of one or more third parties) as described above, that facilitates providing access to computing device 106 to enable various operations as described herein. In other non-limiting implementations, data safe or user data safe 112 can facilitate various interactions and/or functionality as described herein.

In a further non-limiting example, wired network 1422 can include and/or be associated with computing systems or devices 1430 (e.g., one or more appropriately configured computing devices associated with, operated by, or operated on behalf of third parties and networks 1428) as described above, that facilitates providing access to data for third parties and networks 1428 to enable various operations as described herein. In still other non-limiting implementations, computing device 106 can facilitate various interactions and/or functionality as described herein.

Accordingly, in various non-limiting embodiments of the disclosed subject matter, computing environment 1400 can further comprise additional network components (not shown). For example, systems, devices, and/or components can be relatively simplistic and/or lacking certain features to facilitate various techniques of the disclosed subject matter. Thus, particular aspects of the disclosed subject matter can be facilitated by additional network components (not shown) in communication with the devices and/or other components of computing environment 1400.

FIG. 15 depicts an exemplary non-limiting device or system suitable for performing various aspects of the disclosed subject matter. For example, FIG. 15 depicts an exemplary non-limiting device or system 1500 suitable for performing various aspects of the disclosed subject matter. The device or system 1500 can be a stand-alone device or a portion thereof, a specially programmed computing device or a portion thereof (e.g., a memory retaining instructions for performing the techniques as described herein coupled to a processor), and/or a composite device or system comprising one or more cooperating components distributed among several devices, as further described herein. As an example, exemplary non-limiting device or system 1500 can comprise exemplary devices and/or systems described above or as further described below, for example, or portions or combinations thereof.

The above example instructions and other suitable instructions for functionalities as described herein for example, can be retained within memory 1502, and a processor 1504 can be utilized in connection with executing the instructions.

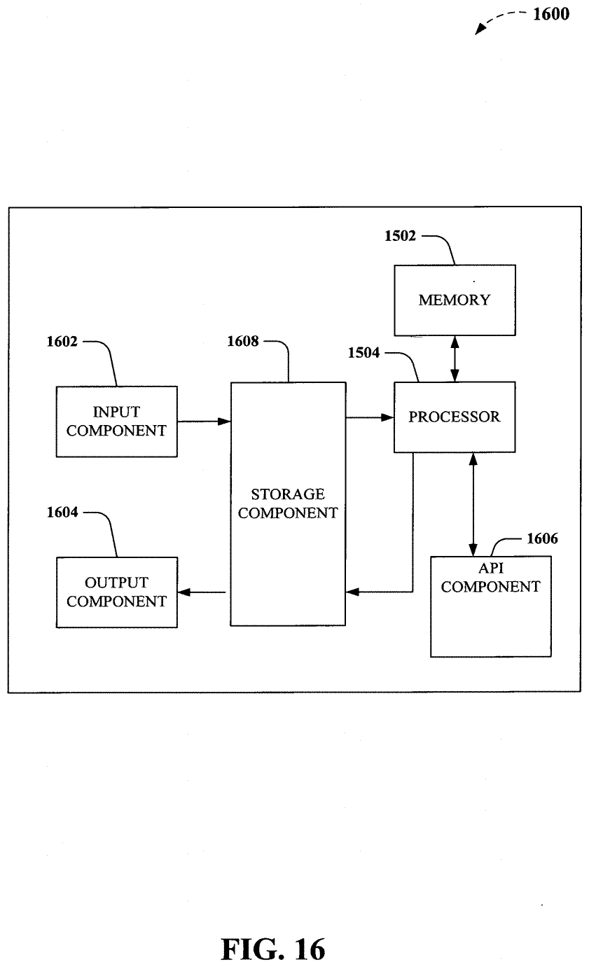

FIG. 16 illustrates an exemplary non-limiting system or device 1600 suitable for performing various aspects of the disclosed subject matter. As an illustrative example, exemplary non-limiting device or system 1600 can comprise exemplary devices or systems described herein or portions thereof. System or device 1600 can comprise an input component 1602 that can receive data or signals, and performs typical actions thereon (e.g., transmits to storage component 1608) the received data or signal. A storage component 1608 can store the received data or signal, as described above, for example, regarding storage component 1320, memory 1502, etc., for subsequent processing or can provide it to a API component 1606, or a processor (e.g., one or more host processors 1318, 1504, etc.), via a memory (e.g., memory 1502, etc.) over a suitable communications bus or otherwise, or to the output component 1604.

Processor 1504 can be a processor dedicated to analyzing and performing functions on information received by input component 1602 and/or generating information for transmission by an output component 1604. Processor 1504 can be a processor that controls one or more portions of system or device 1600, and/or a processor that analyzes information received by input component 1602, generates information for transmission by output component 1604, and performs various functionalities associated API component 1606. API component 1606 can include various algorithms and routines to facilitate communication according specified network protocols and coding algorithms.

While API component 1606 is shown external to the Processor 1504 and memory 1502, it is to be understood that API component 1606 can include code or instructions stored in storage component 1608, storage component 1320, memory 1502, etc., and/or subsequently retained in memory 1502 for execution by Processor 1504. It can be understood that various routines performed by system or device 1600 can utilize artificial intelligence based methods in connection with performing inference and/or probabilistic determinations and/or statistical-based determinations in connection with various aspects of the disclosed subject matter.

System or device 1600 can additionally comprise a memory (e.g., memory 1502, etc.) that is operatively coupled to Processor 1504 and that stores information such as described above, parameters, information, and the like, wherein such information can be employed in connection with implementing various aspects as described herein. Memory 1502 can additionally store received data and/or information, as well as software routines and/or instructions for functionality as described above.

As an illustration of a non-limiting implementation of the disclosed subject matter, an exemplary system or device 1600 can be configured or adapted to provide various functionality characterized by a device associated with user 102 (e.g., device 106 or 1410, etc.). For example, FIG. 14 describes device 1410, associated with user 102, which can comprise an appropriately configured application, or app (e.g., appropriately configured for a specific device, etc.), such as app 1408.

It can be appreciated that exemplary system or device 1600 can be configured and/or adapted in a similar fashion to provide various other functionalities as described herein.

It will be understood that storage component 1608, storage component 1320, memory 1502, and/or any combination thereof as described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1502 is intended to comprise, without being limited to, these and/or any other suitable types of memory, including processor registers and the like. In addition, by way of illustration and not limitation, storage component 1608 and/or storage component 1320, can include conventional storage media as in known in the art (e.g., hard disk drive, solid state disk (SSD), etc.).

It can be understood that various techniques described herein may be implemented in connection with hardware or software or, where appropriate, with a combination of both. As used herein, the terms “device,” “component,” “system” and the like are likewise intended to refer to a computer-related entity, either hardware, a combination of hardware and software, software, or software in execution. For example, a “device,” “component,” subcomponent, “system” portions thereof, and so on, may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

It can be further understood that while a brief overview of exemplary systems, methods, scenarios, and/or devices has been provided, the disclosed subject matter is not so limited. Thus, it can be further understood that various modifications, alterations, addition, and/or deletions can be made without departing from the scope of the embodiments as described herein. Accordingly, similar non-limiting implementations can be used or modifications and additions can be made to the described embodiments for performing the same or equivalent function of the corresponding embodiments without deviating therefrom.

As described above, for example, in exemplary implementations of the disclosed subject matter, a user interface such as a GUI can be provided, for example to facilitate interactions with nodes 108 according to various aspects of the disclosed subject matter, among other related functions. In addition, additional embodiments of the disclosed subject matter can provide computer-executable components that can be stored on a tangible computer readable storage medium (e.g., storage component 1320, storage component 1608, memory 1502, etc.), and that, in response to execution by a computing device (e.g., one or more of host processors 1318, processor 1504, etc.), can cause the computing device to display information (e.g., on the computing device, on a remote computing device over a network, etc), for example, such as via a GUI.

For example, FIG. 16 illustrates an exemplary non-limiting block diagram depicting tangible computer readable storage medium, such as storage component 1608 (e.g., storage component 1320, etc.), that can comprise computer-executable components and that, in response to execution by a computing device (e.g., one or more of host processors 1010, processor 1204, etc.), can cause the computing device to display information (e.g., on the computing device, on a remote computing device over a network, etc). As a non-limiting example, the computer-executable components of the tangible computer readable storage medium can comprise an appropriately configured application, or app, (e.g., appropriately configured for a specific device, etc.) such as described above for app 1408 in FIG. 14, for instance. In another non-limiting example, the computer-executable components of the tangible computer readable storage medium can comprise any of the components (e.g., communication components, user interface component 1304, system management layer 1316, and/or portions thereof, etc.) described herein. In any event, the computer-executable components of the tangible computer readable storage medium can provide a user interface to facilitate interactions with nodes 108, as described herein.

One of ordinary skill in the art can appreciate that the various embodiments of the disclosed subject matter and related systems, devices, and/or methods described herein can be implemented in connection with any computer or other client or server device, which can be deployed as part of a communications system, a computer network, and/or in a distributed computing environment, and can be connected to any kind of data store. In this regard, the various embodiments described herein can be implemented in any computer system or environment having any number of memory or storage units, and any number of applications and processes occurring across any number of storage units or volumes, which may be used in connection with communication systems using the techniques, systems, and methods in accordance with the disclosed subject matter. The disclosed subject matter can apply to an environment with server computers and client computers deployed in a network environment or a distributed computing environment, having remote or local storage. The disclosed subject matter can also be applied to standalone computing devices, having programming language functionality, interpretation and execution capabilities for generating, receiving, storing, and/or transmitting information in connection with remote or local services and processes.

Distributed computing provides sharing of computer resources and services by communicative exchange among computing devices and systems. These resources and services can include the exchange of information, cache storage and disk storage for objects, such as files. These resources and services can also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices can have applications, objects or resources that may utilize disclosed and related systems, devices, and/or methods as described for various embodiments of the subject disclosure.

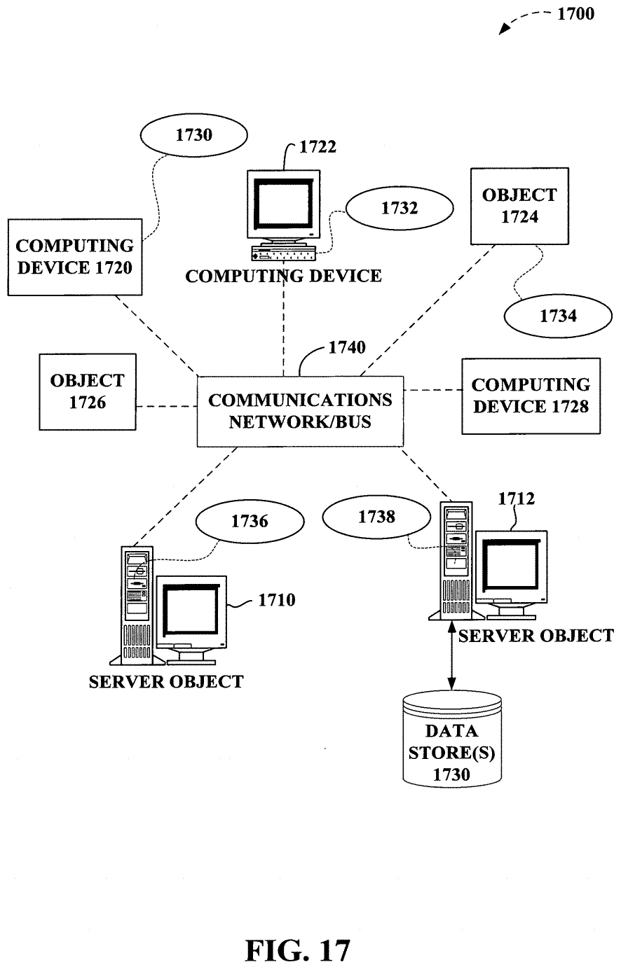

FIG. 17 provides a schematic diagram of an exemplary networked or distributed computing environment. The distributed computing environment comprises computing objects 1710, 1712, etc. and computing objects or devices 1720, 1722, 1724, 1726, 1728, etc., which may include programs, methods, data stores, programmable logic, etc., as represented by applications 1730, 1732, 1734, 1736, 1738. It can be understood that objects 1710, 1712, etc. and computing objects or devices 1720, 1722, 1724, 1726, 1728, etc. may comprise different devices, such as PDAs, audio/video devices, mobile phones, MP3 players, personal computers, laptops, etc.

Each object 1710, 1712, etc. and computing objects or devices 1720, 1722, 1724, 1726, 1728, etc. can communicate with one or more other objects 1710, 1712, etc. and computing objects or devices 1720, 1722, 1724, 1726, 1728, etc. by way of the communications network 1740, either directly or indirectly. Even though illustrated as a single element in FIG. 17, network 1740 may comprise other computing objects and computing devices that provide services to the system of FIG. 17, and/or may represent multiple interconnected networks, which are not shown. Each object 1710, 1712, etc. or 1720, 1722, 1724, 1726, 1728, etc. can also contain an application, such as applications 1730, 1732, 1734, 1736, 1738, that can make use of an API, or other object, software, firmware and/or hardware, suitable for communication with or implementation of disclosed and related systems, devices, methods, and/or functionality provided in accordance with various embodiments of the subject disclosure. Thus, although the physical environment depicted may show the connected devices as computers, such illustration is merely exemplary, and the physical environment may alternatively be depicted or described comprising various digital devices, any of which can employ a variety of wired and/or wireless services, software objects such as interfaces, COM objects, and the like.

There are a variety of systems, components, and network configurations that support distributed computing environments. For example, computing systems can be connected by wired or wireless systems, by local networks or widely distributed networks. Currently, many networks are coupled to the Internet, which can provide an infrastructure for widely distributed computing and can encompass many different networks, though any network infrastructure can be used for exemplary communications made incident to employing disclosed and related systems, devices, and/or methods as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 17, as a non-limiting example, computers 1720, 1722, 1724, 1726, 1728, etc. can be thought of as clients and computers 1710, 1712, etc. can be thought of as servers where servers 1710, 1712, etc. provide data services, such as receiving data from client computers 1720, 1722, 1724, 1726, 1728, etc., storing of data, processing of data, transmitting data to client computers 1720, 1722, 1724, 1726, 1728, etc., although any computer can be considered a client, a server, or both, depending on the circumstances. Any of these computing devices may be processing data, forming metadata, synchronizing data or requesting services or tasks that may implicate disclosed and related systems, devices, and/or methods as described herein for one or more embodiments.

A server is typically a remote computer system accessible over a remote or local network, such as the Internet or wireless network infrastructures. The client process can be active in a first computer system, and the server process can be active in a second computer system, communicating with one another over a communications medium, thus providing distributed functionality and allowing multiple clients to take advantage of the information-gathering capabilities of the server. Any software objects utilized pursuant to disclosed and related systems, devices, and/or methods can be provided standalone, or distributed across multiple computing devices or objects.

In a network environment in which the communications network/bus 1740 is the Internet, for example, the servers 1710, 1712, etc. can be Web servers with which the clients 1720, 1722, 1724, 1726, 1728, etc. communicate via any of a number of known protocols, such as the hypertext transfer protocol (HTTP). Servers 1710, 1712, etc. may also serve as clients 1720, 1722, 1724, 1726, 1728, etc., as may be characteristic of a distributed computing environment.

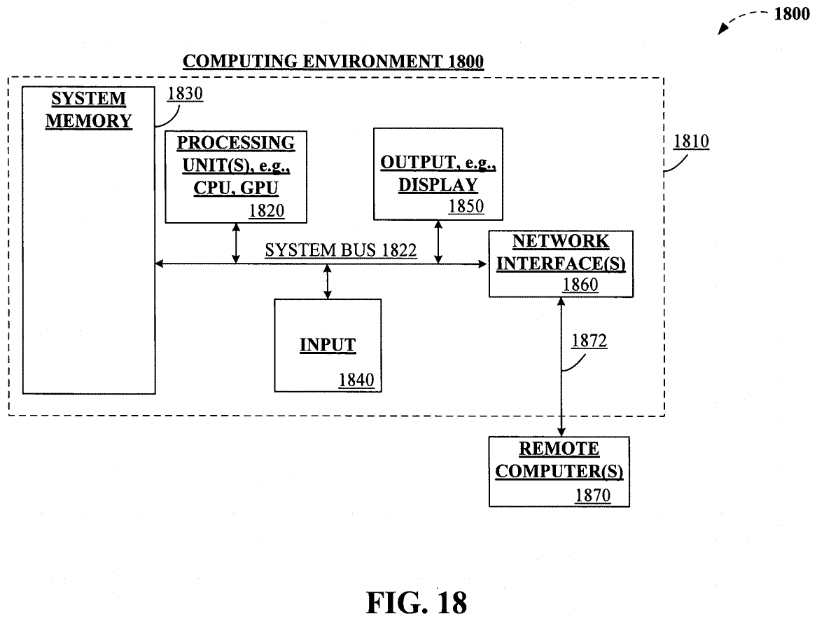

As mentioned, advantageously, the techniques described herein can be applied to devices or systems where it is desirable to employ disclosed and related systems, devices, and/or methods. It should be understood, therefore, that handheld, portable and other computing devices and computing objects of all kinds are contemplated for use in connection with the various disclosed embodiments. Accordingly, the below general purpose remote computer described below in FIG. 18 is but one example of a computing device. Additionally, disclosed and related systems, devices, and/or methods can include one or more aspects of the below general purpose computer, such as display, storage, analysis, control, etc.

Although not required, embodiments can partly be implemented via an operating system, for use by a developer of services for a device or object, and/or included within application software that operates to perform one or more functional aspects of the various embodiments described herein. Software can be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 18 thus illustrates an example of a suitable computing system environment 1800 in which one or aspects of the embodiments described herein can be implemented, although as made clear above, the computing system environment 1800 is only one example of a suitable computing environment and is not intended to suggest any limitation as to scope of use or functionality. Neither should the computing environment 1800 be interpreted as having any dependency or requirement relating to any one or combination of components illustrated in the exemplary operating environment 1800.

With reference to FIG. 18, an exemplary remote device for implementing one or more embodiments includes a general purpose computing device in the form of a computer 1810. Components of computer 1810 can include, but are not limited to, a processing unit 1820, a system memory 1830, and a system bus 1822 that couples various system components including the system memory to the processing unit 1820.

Computer 1810 typically includes a variety of computer readable media and can be any available media that can be accessed by computer 1810. The system memory 1830 can include computer storage media in the form of volatile and/or nonvolatile memory such as read only memory (ROM) and/or random access memory (RAM). By way of example, and not limitation, memory 1830 can also include an operating system, application programs, other program modules, and program data.

A user can enter commands and information into the computer 1810 through input devices 1840. A monitor or other type of display device is also connected to the system bus 1822 via an interface, such as output interface 1850. In addition to a monitor, computers can also include other peripheral output devices such as speakers and a printer, which can be connected through output interface 1850.

The computer 1810 can operate in a networked or distributed environment using logical connections to one or more other remote computers, such as remote computer 1870. The remote computer 1870 can be a personal computer, a server, a router, a network PC, a peer device or other common network node, or any other remote media consumption or transmission device, and can include any or all of the elements described above relative to the computer 1810. The logical connections depicted in FIG. 18 include a network 1872, such local area network (LAN) or a wide area network (WAN), but can also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts can be applied to any network system and any computing device or system in which it is

Also, there are multiple ways to implement the same or similar functionality, e.g., an appropriate API, tool kit, driver code, operating system, control, standalone or downloadable software object, etc. which enables applications and services to use disclosed and related systems, devices, methods, and/or functionality. Thus, embodiments herein are contemplated from the standpoint of an API (or other software object), as well as from a software or hardware object that implements one or more aspects of disclosed and related systems, devices, and/or methods as described herein. Thus, various embodiments described herein can have aspects that are wholly in hardware, partly in hardware and partly in software, as well as in software.

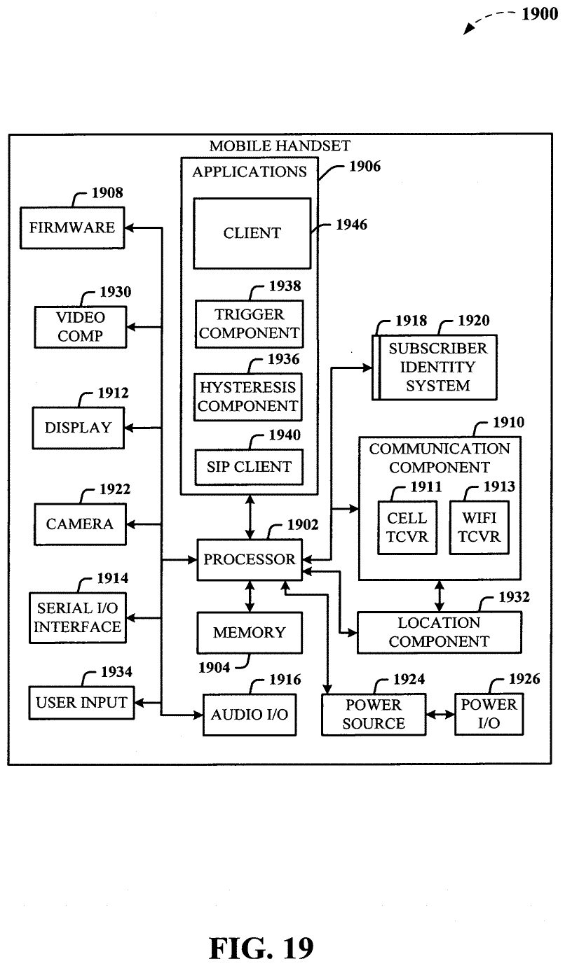

FIG. 19 depicts a schematic diagram of an exemplary mobile device 1900 (e.g., a mobile handset or hand held device) that can facilitate various non-limiting aspects of the disclosed subject matter in accordance with the embodiments described herein. Although mobile handset 1900 is illustrated herein, it will be understood that other devices can be a mobile device, as described above, and that the mobile handset 1900 is merely illustrated to provide context for the embodiments of the subject matter described herein. The following discussion is intended to provide a brief, general description of an example of a suitable environment 1900 in which the various embodiments can be implemented. While the description includes a general context of computer-executable instructions embodied on a tangible computer readable storage medium, those skilled in the art will recognize that the subject matter also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of computer readable media. Computer readable media can comprise any available media that can be accessed by the computer and includes both volatile and non-volatile media, removable and non-removable media. By way of example and not limitation, computer readable media can comprise tangible computer readable storage and/or communication media. Tangible computer readable storage can include volatile and/or non-volatile media, removable and/or non-removable media implemented in any method or technology for storage of information, such as computer readable instructions, data structures, program modules, or other data. Tangible computer readable storage can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media, as contrasted with tangible computer readable storage, typically embodies computer readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable communications media as distinguishable from computer-readable storage media.

The handset 1900 can include a processor 1902 for controlling and processing all onboard operations and functions. A memory 1904 interfaces to the processor 1902 for storage of data and one or more applications 1906 (e.g., communications applications such as browsers, apps, etc.). Other applications can support operation of communications and/or financial communications protocols. The applications 1906 can be stored in the memory 1904 and/or in a firmware 1908, and executed by the processor 1902 from either or both the memory 1904 or/and the firmware 1908. The firmware 1908 can also store startup code for execution in initializing the handset 1900. A communications component 1910 interfaces to the processor 1902 to facilitate wired/wireless communication with external systems, e.g., cellular networks, VoIP networks, and so on. Here, the communications component 1910 can also include a suitable cellular transceiver 1911 (e.g., a GSM transceiver) and/or an unlicensed transceiver 1913 (e.g., Wireless Fidelity (WiFi), Worldwide Interoperability for Microwave Access (WiMax)) for corresponding signal communications. The handset 1900 can be a device such as a cellular telephone, a PDA with mobile communications capabilities, and messaging-centric devices. The communications component 1910 also facilitates communications reception from terrestrial radio networks (e.g., broadcast), digital satellite radio networks, and Internet-based radio services networks.

The handset 1900 includes a display 1912 for displaying text, images, video, telephony functions (e.g., a Caller ID function), setup functions, and for user input. For example, the display 1912 can also be referred to as a “screen” that can accommodate the presentation of multimedia content (e.g., music metadata, messages, wallpaper, graphics, etc.). The display 1912 can also display videos and can facilitate the generation, editing and sharing of video quotes. A serial I/O interface 1914 is provided in communication with the processor 1902 to facilitate wired and/or wireless serial communications (e.g., Universal Serial Bus (USB), and/or Institute of Electrical and Electronics Engineers (IEEE) 2694) through a hardwire connection, and other serial input devices (e.g., a keyboard, keypad, and mouse). This supports updating and troubleshooting the handset 1900, for example. Audio capabilities are provided with an audio I/O component 1916, which can include a speaker for the output of audio signals related to, for example, indication that the user pressed the proper key or key combination to initiate the user feedback signal. The audio I/O component 1916 also facilitates the input of audio signals through a microphone to record data and/or telephony voice data, and for inputting voice signals for telephone conversations.

The handset 1900 can include a slot interface 1918 for accommodating a SIC (Subscriber Identity Component) in the form factor of a card Subscriber Identity Module (SIM) or universal SIM 1920, and interfacing the SIM card 1920 with the processor 1902. However, it is to be appreciated that the SIM card 1920 can be manufactured into the handset 1900, and updated by downloading data and software.

The handset 1900 can process Internet Protocol (IP) data traffic through the communication component 1910 to accommodate IP traffic from an IP network such as, for example, the Internet, a corporate intranet, a home network, a person area network, etc., through an ISP or broadband cable provider. Thus, VoIP traffic can be utilized by the handset 1900 and IP-based multimedia content can be received in either an encoded or a decoded format.

A video processing component 1922 (e.g., a camera and/or associated hardware, software, etc.) can be provided for decoding encoded multimedia content. The video processing component 1922 can aid in facilitating the generation and/or sharing of video. The handset 1900 also includes a power source 1924 in the form of batteries and/or an alternating current (AC) power subsystem, which power source 1924 can interface to an external power system or charging equipment (not shown) by a power input/output (I/O) component 1926.

The handset 1900 can also include a video component 1930 for processing video content received and, for recording and transmitting video content. For example, the video component 1930 can facilitate the generation, editing and sharing of video. A location-tracking component 1932 facilitates geographically locating the handset 1900. A user input component 1934 facilitates the user inputting data and/or making selections as previously described. The user input component 1934 can also facilitate selecting perspective recipients for fund transfer, entering amounts requested to be transferred, indicating account restrictions and/or limitations, as well as composing messages and other user input tasks as required by the context. The user input component 1934 can include such conventional input device technologies such as a keypad, keyboard, mouse, stylus pen, and/or touch screen, for example.

Referring again to the applications 1906, a hysteresis component 1936 facilitates the analysis and processing of hysteresis data, which is utilized to determine when to associate with an access point. A software trigger component 1938 can be provided that facilitates triggering of the hysteresis component 1938 when a WiFi transceiver 1913 detects the beacon of the access point. A SIP client 1940 enables the handset 1900 to support SIP protocols and register the subscriber with the SIP registrar server. The applications 1906 can also include a communications application or client 1946 that, among other possibilities, can facilitate user interface component functionality as described above.

The handset 1900, as indicated above related to the communications component 1910, includes an indoor network radio transceiver 1913 (e.g., WiFi transceiver). This function supports the indoor radio link, such as IEEE 802.11, for the dual-mode Global System for Mobile Communications (GSM) handset 1900. The handset 1900 can accommodate at least satellite radio services through a handset that can combine wireless voice and digital radio chipsets into a single handheld device.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into systems. That is, at least a portion of the devices and/or processes described herein can be integrated into a system via a reasonable amount of experimentation. Those having skill in the art will recognize that a typical system can include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control device (e.g., feedback for sensing position and/or velocity; control devices for moving and/or adjusting parameters). A typical system can be implemented utilizing any suitable commercially available components, such as those typically found in data computing/communication and/or network computing/communication systems.

Various embodiments of the disclosed subject matter sometimes illustrate different components contained within, or connected with, other components. It is to be understood that such depicted architectures are merely exemplary, and that, in fact, many other architectures can be implemented which achieve the same and/or equivalent functionality. In a conceptual sense, any arrangement of components to achieve the same and/or equivalent functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected,” “operably coupled,” “communicatively connected,” and/or “communicatively coupled,” to each other to achieve the desired functionality, and any two components capable of being so associated can also be viewed as being “operably couplable” or “communicatively couplable ” to each other to achieve the desired functionality. Specific examples of operably couplable or communicatively couplable can include, but are not limited to, physically mateable and/or physically interacting components, wirelessly interactable and/or wirelessly interacting components, and/or logically interacting and/or logically interactable components.

With respect to substantially any plural and/or singular terms used herein, those having skill in the art can translate from the plural to the singular and/or from the singular to the plural as can be appropriate to the context and/or application. The various singular/plural permutations may be expressly set forth herein for the sake of clarity, without limitation.

It will be understood by those skilled in the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes, but is not limited to,” etc.). It will be further understood by those skilled in the art that, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limit any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g.,“a system having at least one of A, B, and C” would include, but not be limited to, systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g.,“a system having at least one of A, B, or C” would include but not be limited to systems that have A alone, B alone, C alone, A and B together, A and C together, B and C together, and/or A, B, and C together, etc.). It will be further understood by those skilled in the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into sub-ranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be noted that various embodiments of the disclosed subject matter have been described herein for purposes of illustration, and that various modifications may be made without departing from the scope and spirit of the subject disclosure. Accordingly, the various embodiments disclosed herein are not intended to be limiting, with the true scope and spirit being indicated by the appended claims.

In addition, the words “exemplary” and “non-limiting” are used herein to mean serving as an example, instance, or illustration. For the avoidance of doubt, the subject matter disclosed herein is not limited by such examples. Moreover, any aspect or design described herein as “an example,” “an illustration,” “exemplary” and/or “non-limiting” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements, as described above.

As mentioned, the various techniques described herein can be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on computer and the computer can be a component. In addition, one or more components can reside within a process and/or thread of execution and a component can be localized on one computer and/or distributed between two or more computers.

Systems described herein can be described with respect to interaction between several components. It can be understood that such systems and components can include those components or specified sub-components, some of the specified components or sub-components, or portions thereof, and/or additional components, and various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and that any one or more middle component layers, such as a management layer, can be provided to communicatively couple to such sub-components in order to provide integrated functionality, as mentioned. Any components described herein can also interact with one or more other components not specifically described herein but generally known by those of skill in the art.

As mentioned, in view of the exemplary systems described herein, methods that can be implemented in accordance with the described subject matter can be better appreciated with reference to the flowcharts of the various figures and vice versa. While for purposes of simplicity of explanation, the methods can be shown and described as a series of blocks, it is to be understood and appreciated that the claimed subject matter is not limited by the order of the blocks, as some blocks can occur in different orders and/or concurrently with other blocks from what is depicted and described herein. Where non-sequential, or branched, flow is illustrated via flowchart, it can be understood that various other branches, flow paths, and orders of the blocks, can be implemented which achieve the same or a similar result. Moreover, not all illustrated blocks can be required to implement the methods described hereinafter.

While the disclosed subject matter has been described in connection with the disclosed embodiments and the various figures, it is to be understood that other similar embodiments may be used or modifications and additions may be made to the described embodiments for performing the same function of the disclosed subject matter without deviating therefrom. Still further, multiple processing chips or multiple devices can share the performance of one or more functions described herein, and similarly, storage can be effected across a plurality of devices. In other instances, variations of process parameters (e.g., configuration, number of components, aggregation of components, process step timing and order, addition and/or deletion of process steps, addition of preprocessing and/or post-processing steps, etc.) can be made to further optimize the provided structures, devices and methods, as shown and described herein. In any event, the systems, structures and/or devices, as well as the associated methods described herein have many applications in various aspects of the disclosed subject matter, and so on. Accordingly, the invention should not be limited to any single embodiment, but rather should be construed in breadth, spirit and scope in accordance with the appended claims.

I claim:

1. A system for connection to a network that comprises a plurality of computers hosting a plurality of blockchains with differing protocols, the system comprising:
A computing device;
the computing device comprising
a processor,
a memory,
a bus connecting the processor and the memory, and
a network connection;
the computing device configured to:
receive a collection of data to be posted in a plurality of blockchains, each of the plurality of blockchains having an individual smart contract;
receive an indication of each blockchain of the plurality of blockchains in which the collection of data is to be posted;
receive public key information for each indicated blockchain; and
for each of the indicated blockchains:
attempt to validate the indicated blockchain;
if the indicated blockchain is validated, access the individual smart contract associated with the validated blockchain; and
post to the validated blockchain, data from the collection of data and public key information for the validated blockchain, via the individual smart contract associated with the validated blockchain.

2. The system of claim 1 wherein the computing device is further configured to:
assign a common identifier to the collection of data;
post the common identifier to the validated blockchain, via the individual smart contract associated with the validated blockchain.

3. The system of claim 1 wherein the computing device is further configured to:
assign a common identifier to the collection of data; and
post the common identifier to a plurality of validated blockchains, via each of the individual smart contracts associated with each of the validated blockchains.

4. The system of claim 1 wherein:
the collection of data comprises a plurality of data items;
a first data item of the plurality of data items is designated for posting to only a first indicated blockchain; and
a second data item of the plurality of data items is designated for posting to only a second indicated blockchain.

5. The system of claim 1 wherein:
the first indicated blockchain is of a first type of blockchain; and
the second indicated blockchain is of a second type of blockchain, wherein the second type of blockchain is structured differently than the first type of blockchain.

6. The system of claim 1 wherein:
the first type of blockchain is chosen from the group consisting of Ethereum, alastria, hyperledger, and any fork of Ethereum, alastria, or hyperledger.

7. The system of claim 4 wherein the computing device is further configured to:
retrieve only one of either the first data item or the second data item; and
wherein the retrieving comprises using an appropriate public key from the public key information and a private key.

8. A method for use with a network configured for communications with blockchains, the method comprising:
receiving a collection of data to be posted in a plurality of blockchains, each of the plurality of blockchains having an individual smart contract;
receiving an indication of each blockchain of the plurality of blockchains in which the collection of data is to be posted;
receiving public key information for each indicated blockchain; and
for each of the indicated blockchains:
attempting to validate the indicated blockchain;
if the indicated blockchain is validated, accessing the individual smart contract associated with the validated blockchain; and
posting to the validated blockchain, data from the collection of data and public key information for the validated blockchain, via the individual smart contract associated with the validated blockchain.

9. The method of claim 8 wherein the instructions further comprise:
assigning a common identifier to the collection of data;
posting the common identifier to the validated blockchain, via the individual smart contract associated with the validated blockchain.

10. The method of claim 8 wherein the instructions further comprise:
assigning a common identifier to the collection of data; and
posting the common identifier to a plurality of validated blockchains, via each of the individual smart contracts associated with each of the validated blockchains.

11. The method of claim 8 wherein,
the collection of data comprises a plurality of data items;
a first data item of the plurality of data items is designated for posting to only a first indicated blockchain; and
a second data item of the plurality of data items is designated for posting to only a second indicated blockchain.

12. The method of claim 11 wherein,
the first indicated blockchain is of a first type of blockchain; and
the second indicated blockchain is of a second type of blockchain, wherein the second type of blockchain is structured differently than the first type of blockchain.

13. The method of claim 12 wherein,
the first type of blockchain is chosen from the group consisting of ethereum, alastria, hyperledger, and any fork of Ethereum, alastria, or hyperledger.

14. The method of claim 12 further comprising,
retrieving only one of either the first data item or the second data item; and
wherein the retrieving comprises using an appropriate public key from the public key information and a private key.

15. A non-transitory computer-readable medium adapted for use with a computer coupled to a network such that communications with blockchains are enabled, the non-transitory computer-readable medium comprising instructions encoded thereon, the instructions comprising:
instructions for receiving a collection of data to be posted in a plurality of blockchains, each of the plurality of blockchains having an individual smart contract;
instructions for receiving an indication of each blockchain of the plurality of blockchains in which the collection of data is to be posted;
instructions for receiving public key information for each indicated blockchain; and
for each of the indicated blockchains:
instructions for attempting to validate the indicated blockchain;
if the indicated blockchain is validated, instructions for accessing the individual smart contract associated with the validated blockchain; and
instructions for posting to the validated blockchain, data from the collection of data and public key information for the validated blockchain, via the individual smart contract associated with the validated blockchain.

16. The medium of claim 15 wherein the instructions further comprise:
instructions for assigning a common identifier to the collection of data;
instructions for posting the common identifier to the validated blockchain, via the individual smart contract associated with the validated blockchain.

17. The medium of claim 15 wherein the instructions further comprise:
instructions for assigning a common identifier to the collection of data; and
instructions for posting the common identifier to a plurality of validated blockchains, via each of the individual smart contracts associated with each of the validated blockchains.

18. The medium of claim 15 wherein,
the collection of data comprises a plurality of data items;
a first data item of the plurality of data items is designated for posting to only a first indicated blockchain; and
a second data item of the plurality of data items is designated for posting to only a second indicated blockchain.

19. The medium of claim 18 wherein,
the first indicated blockchain is of a first type of blockchain; and
the second indicated blockchain is of a second type of blockchain, wherein the second type of blockchain is structured differently than the first type of blockchain.

20. The medium of claim 19 wherein,
the first type of blockchain is chosen from the group consisting of Ethereum, alastria, hyperledger, and any fork of Ethereum, alastria, or hyperledger.
